(19) United States
(12) Patent Application Publication
(10) Pub. No.: US 2002/0081012 A1
(43) Pub. Date: Jun. 27, 2002

(54) Image analyzing method and apparatus

(75) Inventor: Masashi Hakamata, Kanagawa (JP)

Correspondence Address: SUGHRUE, MION, ZINN, MACPEAK & SEAS, PLLC, 2100 Pennsylvania Avenue, N.W., Washington, DC, 20037-3202, US

(73) Assignee: Fuji Photo Film Co., LTD.

(21) Appl. No.: 10/004,873

(22) Filed: Dec. 7, 2001

(30) Foreign Application Priority Data
Dec. 13, 2000 (JP) 2000-379213

(51) Int. Cl. G06K 9/00

(52) U.S. Cl. 382/132

(57) ABSTRACT

An image analyzing apparatus includes a plurality of stimulating ray sources, a light detector and an image reading apparatus for producing image data by photoelectrically detecting fluorescence emission by the light detector, the image analyzing apparatus further including a template producing section for producing a template based on template data produced by photoelectrically detecting by the light detector of the image reading apparatus a plurality of spots of a specific binding substance formed on a substrate by spot-like dropping the specific binding substance and defining regions of interest to be quantified based on the template, and a quantitative analyzer for defining regions of interest to be quantified in the image data based on the template produced by the template producing section and effecting quantitative analysis. According to thus constituted image analyzing apparatus, it is possible to define a region of interest to be quantitatively analyzed in a desired manner and accurately effect quantitative analysis.

### BACKGROUND OF THE INVENTION

The present invention relates to an image analyzing method and apparatus and, particularly, to such an image analyzing method and apparatus for detecting a micro-array image, which can define a region of interest to be quantitatively analyzed in a desired manner and accurately effect quantitative analysis.

### DESCRIPTION OF THE PRIOR ART

An autoradiographic system using as a detecting material for detecting radiation a stimulable phosphor which can absorb, store and record the energy of radiation when it is irradiated with radiation and which, when it is then stimulated by an electromagnetic wave having a specified wavelength, can release stimulated emission whose light amount corresponds to the amount of radiation with which it was irradiated is known, which comprises the steps of introducing a radioactive labeling substance into an organism, using the organism or a part of the tissue of the organism as a specimen, superposing the specimen and a stimulable phosphor sheet formed with a stimulable phosphor layer for a certain period of time, storing and recording radiation energy in a stimulable phosphor contained in the stimulable phosphor layer, scanning the stimulable phosphor layer with an electromagnetic wave to excite the stimulable phosphor, photoelectrically detecting the stimulated emission released from the stimulable phosphor to produce digital image signals, effecting image processing on the obtained digital image signals, and reproducing an image on displaying means such as a CRT or the like or a photographic film (see, for example, Japanese Patent Publication No. 1-60784, Japanese Patent Publication No. 1-60782, Japanese Patent Publication No. 4-3952 and the like).

Unlike the system using a photographic film, according to the autoradiographic system using the stimulable phosphor as a detecting material, development, which is chemical processing, becomes unnecessary. Further, it is possible to reproduce a desired image by effecting image processing on the obtained image data and effect quantitative analysis using a computer. Use of a stimulable phosphor in these processes is therefore advantageous.

On the other hand, a fluorescence detecting system using a fluorescent substance as a labeling substance instead of a radioactive labeling substance in the autoradiographic system is known. According to this system, it is possible to study a genetic sequence, to study the expression level of a gene, and to effect separation or identification of protein or estimation of the molecular weight or properties of protein or the like. For example, this system can perform a process including the steps of distributing a plurality of DNA fragments on a gel support by means of electrophoresis after a fluorescent dye was added to a solution containing a plurality of DNA fragments to be distributed, or distributing a plurality of DNA fragments on a gel support containing a fluorescent dye, or dipping a gel support on which a plurality of DNA fragments have been distributed by means of electrophoresis in a solution containing a fluorescent dye, thereby labeling the electrophoresed DNA fragments, exciting the fluorescent dye by a stimulating ray to cause it to release fluorescent light, detecting the released fluorescent light to produce an image and detecting the distribution of the DNA fragments on the gel support. This system can also perform a process including the steps of distributing a plurality of DNA fragments on a gel support by means of electrophoresis, denaturing the DNA fragments, transferring at least a part of the denatured DNA fragments onto a transfer support such as a nitrocellulose support by the Southern blotting method, hybridizing a probe prepared by labeling target DNA and DNA or RNA complementary thereto with the denatured DNA fragments, thereby selectively labeling only the DNA fragments complementary to the probe DNA or probe RNA, exciting the fluorescent dye by a stimulating ray to cause it to release fluorescent light, detecting the released fluorescent light to produce an image and detecting the distribution of the target DNA on the transfer support. This system can further perform a process including the steps of preparing a DNA probe complementary to DNA containing a target gene labeled by a labeling substance, hybridizing it with DNA on a transfer support, combining an enzyme with the complementary DNA labeled by a labeling substance, causing the enzyme to contact a fluorescent substance, transforming the fluorescent substance to a fluorescent substance having fluorescent light releasing property, exciting the thus produced fluorescent substance by a stimulating ray to release fluorescent light, detecting the fluorescent light to produce an image and detecting the distribution of the target DNA on the transfer support. This fluorescence detecting system is advantageous in that a genetic sequence or the like can be easily detected without using a radioactive substance.

Further, a micro-array detecting system has been recently developed, which comprises the steps of using a spotting device to drop at different positions on the surface of a carrier such as a slide glass plate, a membrane filter or the like specific binding substances, which can specifically bind with a substance derived from a living organism such as a hormone, tumor marker, enzyme, antibody, antigen, abzyme, other protein, a nuclear acid, cDNA, DNA, RNA or the like and whose sequence, base length, composition and the like are known, thereby forming a number of independent spots, specifically binding the specific binding substances using a hybridization method or the like with a substance derived from a living organism such as a hormone, tumor marker, enzyme, antibody, antigen, abzyme, other protein, a nuclear acid, cDNA, DNA or mRNA, which is gathered from a living organism by extraction, isolation or the like or is further subjected to chemical processing, chemical modification or the like and which is labeled with a labeling substance such as a fluorescent substance, dye or the like, thereby forming a micro-array, irradiating the micro-array with a stimulating ray, photoelectrically detecting light such as fluorescence emitted from a labeling substance such as a fluorescent substance, dye or the like, and analyzing the substance derived from a living organism. This micro-array image detecting system is advantageous in that a substance derived from a living organism can be analyzed in a short time period by forming a number of spots of specific binding substances at different positions of the surface of a carrier such as a slide glass plate at high density and hybridizing them with a substance derived from a living organism and labeled with a labeling substance.

In the micro-array image detecting system, a substance derived from a living organism is analyzed by labeling the substance derived from a living organism with one kind of a fluorescent dye and quantifying an amount thereof hybridized with a specific binding substance, or labeling a substance derived from a living organism with two or more kinds of fluorescent dyes which are effectively stimulated by different wavelengths of stimulating rays from each other and quantifying and analyzing the difference in expression using a computer, and in either case it is essential to define a region of interest to be quantified using a computer.

However, in the case of spotting a specific binding substance onto the surface of a substrate such as a slide glass plate, a membrane filter or the like using a spotter, it is difficult to spot a specific binding substance onto a desired position on the surface of a substrate such as a slide glass plate, a membrane filter or the like due to spotting error of the spotter. Therefore, in the case of hybridizing a substance derived from a living organism and labeled with one kind or two or more kinds of fluorescent dyes with a specific binding substance, quantifying the hybridized amount or the difference in expression and effecting analysis by computer, since any spot which is not labeled with a fluorescent dye cannot be photoelectrically detected, the positions on the substrate where spots are formed cannot be judged and, as a result, it is difficult to define a region of interest to be quantified in a desired manner.

### SUMMARY OF THE INVENTION

It is therefore an object of the present invention to provide an image analyzing method and apparatus for detecting a micro-array image, which can define a region of interest to be quantitatively analyzed in a desired manner and accurately effect quantitative analysis.

The above and other objects of the present invention can be accomplished by an image analyzing method comprising the steps of spot-like dropping a specific binding substance onto a substrate to form a plurality of spots, photoelectrically detecting all of the thus formed spots to produce template data, producing a template for defining regions of interest to be quantified based on the thus produced template data and effecting quantitative analysis based on the template.

According to this aspect of the present invention, since the image analyzing method comprises the steps of spot-like dropping a specific binding substance onto a substrate to form a plurality of spots, photoelectrically detecting all of the thus formed spots to produce template data, producing a template for defining regions of interest to be quantified based on the thus produced template data and effecting quantitative analysis based on the template, even if a specific binding substance cannot be spotted onto a desired position on the surface of a substrate such as a slide glass plate, a membrane filter or the like due to spotting error of the spotter, it is possible to ascertain the positions of all spots and, therefore, it is possible to produce a template for defining regions of interest to be quantified in a desired manner and accurately effect quantitative analysis based on the template.

In a preferred aspect of the present invention, the image analyzing method comprises the steps of spot-like dropping a fluorescent dye for producing template data capable of being efficiently stimulated by a stimulating ray having a different wavelength from that of a stimulating ray capable of efficiently stimulating a fluorescent dye labeling a target substance derived from a living organism onto the substrate together with the specific binding substance to form a plurality of spots, irradiating the plurality of spots with a stimulating ray having a wavelength capable of efficiently stimulating the fluorescent dye for producing template data, thereby stimulating the fluorescent dye for producing template data, photoelectrically detecting fluorescence emission released from the fluorescent dye for producing template data, producing the template data, producing a template for defining regions of interest to be quantified based on the thus produced template data and effecting quantitative analysis based on the template.

According to this preferred aspect of the present invention, since the image analyzing method comprises the steps of spot-like dropping a fluorescent dye for producing template data capable of being efficiently stimulated by a stimulating ray having a different wavelength from that of a stimulating ray capable of efficiently stimulating a fluorescent dye labeling a target substance derived from a living organism onto the substrate together with the specific binding substance to form a plurality of spots, irradiating the plurality of spots with a stimulating ray having a wavelength capable of efficiently stimulating the fluorescent dye for producing template data, thereby stimulating the fluorescent dye for producing template data, photoelectrically detecting fluorescence emission released from the fluorescent dye for producing template data, and producing the template data, it is possible to accurately photoelectrically detect all of the spots formed by dropping a specific binding substance onto the substrate to produce template data, to produce a template for defining regions of interest to be quantified based on the thus produced template data and effect quantitative analysis based on the template and it is therefore possible to produce a template for defining regions of interest to be quantified in a desired manner and accurately effect quantitative analysis based on the template.

In a further preferred aspect of the present invention, the image analyzing method comprises the steps of spot-like dropping a fluorescent dye for producing template data onto the substrate together with the specific binding substance to form a plurality of spots, hybridizing the substance derived from a living organism and labeled with a fluorescent dye with the specific binding substance, irradiating the plurality of spots with a stimulating ray having a wavelength capable of efficiently stimulating the fluorescent dye for producing template data, thereby stimulating the fluorescent dye for producing template data, photoelectrically detecting fluorescence emission released from the fluorescent dye for producing template data, producing the template data, producing a template for defining regions of interest to be quantified based on the thus produced template data, irradiating the plurality of spots with a stimulating ray capable of efficiently stimulating the fluorescent dye to stimulate the fluorescent dye labeling the substance derived from a living organism, photoelectrically detecting fluorescence emission released from the fluorescent dye to produce image data, and effecting quantitative analysis based on the template.

According to this preferred aspect of the present invention, since the image analyzing method comprises the steps of spot-like dropping a fluorescent dye for producing template data onto the substrate together with the specific binding substance to form a plurality of spots, hybridizing the substance derived from a living organism and labeled with a fluorescent dye with the specific binding substance, irradiating the plurality of spots with a stimulating ray having a wavelength capable of efficiently stimulating the fluorescent dye for producing template data, thereby stimulating the fluorescent dye for producing template data, photoelectrically detecting fluorescence emission released from the fluorescent dye for producing template data, producing the template data, producing the template for defining regions of interest to be quantified based on the thus produced template data, irradiating the plurality of spots with a stimulating ray capable of efficiently stimulating the fluorescent dye to stimulate the fluorescent dye labeling the substance derived from a living organism, photoelectrically detecting fluorescence emission released from the fluorescent dye to produce image data, and effecting quantitative analysis based on the template, all fluorescence emission released from the fluorescent dye labeling the substance derived from a living organism and photoelectrically detected are released from the spots included in the template data and it is therefore possible to produce a template for defining regions of interest to be quantified in a desired manner and effect quantitative analysis with extremely high accuracy based on the template.

In another preferred aspect of the present invention, the image analyzing method comprises the steps of spot-like dropping a fluorescent dye for producing template data onto the substrate together with the specific binding substance to form a plurality of spots, hybridizing the substance derived from a living organism and labeled with a fluorescent dye with the specific binding substance, irradiating the plurality of spots with a stimulating ray having a wavelength capable of efficiently stimulating the fluorescent dye labeling the substance derived from a living organism to stimulate the fluorescent dye, photoelectrically detecting fluorescence emission released from the fluorescent dye to produce image data, irradiating the plurality of spots with a stimulating ray having a wavelength capable of efficiently stimulating the fluorescent dye for producing template data, thereby stimulating the fluorescent dye for producing template data, photoelectrically detecting fluorescence emission released from the fluorescent dye for producing template data, producing the template data, producing a template for defining regions of interest to be quantified based on the thus produced template data, and effecting quantitative analysis based on the template.

According to this preferred aspect of the present invention, since the image analyzing method comprises the steps of spot-like dropping a fluorescent dye for producing template data onto the substrate together with the specific binding substance to form a plurality of spots, hybridizing the substance derived from a living organism and labeled with a fluorescent dye with the specific binding substance, irradiating the plurality of spots with a stimulating ray having a wavelength capable of efficiently stimulating the fluorescent dye labeling the substance derived from a living organism to stimulate the fluorescent dye, photoelectrically detecting fluorescence emission released from the fluorescent dye to produce image data, irradiating the plurality of spots with a stimulating ray having a wavelength capable of efficiently stimulating the fluorescent dye for producing template data, thereby stimulating the fluorescent dye for producing template data, photoelectrically detecting fluorescence emission released from the fluorescent dye for producing template data, producing the template data, producing the template for defining regions of interest to be quantified based on the thus produced template data, and effecting quantitative analysis based on the template, all fluorescence emission released from the fluorescent dye labeling the substance derived from a living organism and photoelectrically detected are released from the spots included in the template data and it is therefore possible to produce a template for defining regions of interest to be quantified in a desired manner and effect quantitative analysis with extremely high accuracy based on the template.

In another preferred aspect of the present invention, the image analyzing method comprises the steps of spot-like dropping a fluorescent dye for producing template data onto the substrate together with the specific binding substance to form a plurality of spots, irradiating the plurality of spots with a stimulating ray having a wavelength capable of efficiently stimulating the fluorescent dye for producing template data, thereby stimulating the fluorescent dye for producing template data, photoelectrically detecting fluorescence emission released from the fluorescent dye for producing template data, producing the template data, producing a template for defining regions of interest to be quantified based on the thus produced template data, hybridizing the substance derived from a living organism and labeled with a fluorescent dye with the specific binding substance forming the plurality of spots on the substrate, irradiating the plurality of spots with a stimulating ray having a wavelength capable of efficiently stimulating the fluorescent dye labeling the substance derived from a living organism to stimulate the fluorescent dye, photoelectrically detecting fluorescence emission released from the fluorescent dye to produce image data, defining regions of interest to be quantified in the image data based on the template and effecting quantitative analysis based on the template.

According to this preferred aspect of the present invention, since the image analyzing method comprises the steps of spot-like dropping a fluorescent dye for producing template data onto the substrate together with the specific binding substance to form a plurality of spots, irradiating the plurality of spots with a stimulating ray having a wavelength capable of efficiently stimulating the fluorescent dye for producing template data, thereby stimulating the fluorescent dye for producing template data, photoelectrically detecting fluorescence emission released from the fluorescent dye for producing template data, producing the template data, producing the template for defining regions of interest to be quantified based on the thus produced template data, hybridizing the substance derived from a living organism and labeled with a fluorescent dye with the specific binding substance forming the plurality of spots on the substrate, irradiating the plurality of spots with a stimulating ray having a wavelength capable of efficiently stimulating the fluorescent dye labeling the substance derived from a living organism to stimulate the fluorescent dye, photoelectrically detecting fluorescence emission released from the fluorescent dye to produce image data, defining regions of interest to be quantified in the image data based on the template, and effecting quantitative analysis based on the template, all fluorescence emission released from the fluorescent dye labeling the substance derived from a living organism and photoelectrically detected are released from the spots included in the template data and it is therefore possible to produce a template for defining regions of interest to be quantified in a desired manner and effect quantitative analysis with extremely high accuracy based on the template.

In another preferred aspect of the present invention, the fluorescent dye for producing template data is contained in a polymer and the image analyzing method comprises the steps of causing the polymer to contain the specific binding substance, spot-like dropping the polymer onto the substrate to form a plurality of spots, irradiating the plurality of spots with a stimulating ray having a wavelength capable of efficiently stimulating the fluorescent dye for producing template data, thereby stimulating the fluorescent dye for producing template data, photoelectrically detecting fluorescence emission released from the fluorescent dye for producing template data, producing the template data, producing a template for defining regions of interest to be quantified based on the thus produced template data, and effecting quantitative analysis based on the template.

According to this preferred aspect of the present invention, since the fluorescent dye for producing template data is contained in a polymer, which has high viscocity, and the image analyzing method comprises the steps of causing the polymer to contain the specific binding substance, spot-like dropping the polymer onto the substrate to form a plurality of spots, irradiating the plurality of spots with a stimulating ray having a wavelength capable of efficiently stimulating the fluorescent dye for producing template data, thereby stimulating the fluorescent dye for producing template data, photoelectrically detecting fluorescence emission released from the fluorescent dye for producing template data, producing the template data, and producing the template for defining regions of interest to be quantified based on the thus produced template data, it is sufficient to cause the polymer having high viscosity and used for forming the spots with high density to contain the specific binding substance and spot-like drop the polymer onto the substrate, thereby forming a plurality of spots and, therefore, it is possible to produce template data with a simple operation, produce a template for defining regions of interest to be quantified based on the thus produced template data, define the regions of interest to be quantified based on the template in a desired manner, and effect quantitative analysis with extremely high accuracy.

In a further preferred aspect of the present invention, the fluorescent dye for producing template data is contained in the polymer and the image analyzing method comprises the steps of causing the polymer to contain the specific binding substance, spot-like dropping the polymer onto the substrate to form a plurality of spots, hybridizing the substance derived from a living organism and labeled with a fluorescent dye with the specific binding substance, irradiating the plurality of spots with a stimulating ray having a wavelength capable of efficiently stimulating the fluorescent dye for producing template data, thereby stimulating the fluorescent dye for producing template data, photoelectrically detecting fluorescence emission released from the fluorescent dye for producing template data, producing the template data, producing a template for defining regions of interest to be quantified based on the thus produced template data, irradiating the plurality of spots with a stimulating ray having a wavelength capable of efficiently stimulating the fluorescent dye labeling the substance derived from a living organism to stimulate the fluorescent dye, photoelectrically detecting fluorescence emission released from the fluorescent dye to produce image data, and effecting quantitative analysis based on the template.

According to this preferred aspect of the present invention, since the fluorescent dye for producing template data is contained in a polymer and the image analyzing method comprises the steps of causing the polymer to contain the specific binding substance, spot-like dropping the polymer onto the substrate to form a plurality of spots, hybridizing the substance derived from a living organism and labeled with a fluorescent dye with the specific binding substance, irradiating the plurality of spots with a stimulating ray having a wavelength capable of efficiently stimulating the fluorescent dye for producing template data, thereby stimulating the fluorescent dye for producing template data, photoelectrically detecting fluorescence emission released from the fluorescent dye for producing template data, producing the template data, producing the template for defining regions of interest to be quantified based on the thus produced template data, irradiating the plurality of spots with a stimulating ray having a wavelength capable of efficiently stimulating the fluorescent dye labeling the substance derived from a living organism to stimulate the fluorescent dye, photoelectrically detecting fluorescence emission released from the fluorescent dye to produce image data, and effecting quantitative analysis based on the template, it is sufficient to cause the polymer having high viscosity and used for forming the spots with high density to contain the specific binding substance and spot-like drop the polymer onto the substrate, thereby forming a plurality of spots and, therefore, it is possible to produce template data with a simple operation, produce a template for defining regions of interest to be quantified based on the thus produced template data, define the regions of interest to be quantified based on the template in a desired manner, and effect quantitative analysis with extremely high accuracy.

In another preferred aspect of the present invention, the fluorescent dye for producing template data is contained in the polymer and the image analyzing method comprises the steps of causing the polymer to contain the specific binding substance, spot-like dropping the polymer onto the substrate to form a plurality of spots, hybridizing the substance derived from a living organism and labeled with a fluorescent dye with the specific binding substance, irradiating the plurality of spots with a stimulating ray having a wavelength capable of efficiently stimulating the fluorescent dye labeling the substance derived from a living organism, thereby stimulating the fluorescent dye, photoelectrically detecting fluorescence emission released from the fluorescent dye to produce image data, irradiating the plurality of spots with a stimulating ray having a wavelength capable of efficiently stimulating the fluorescent dye for producing template data, thereby stimulating the fluorescent dye for producing template data, photoelectrically detecting fluorescence emission released from the fluorescent dye for producing template data, producing the template data, producing a template for defining regions of interest to be quantified based on the thus produced template data, and effecting quantitative analysis based on the template.

According to this preferred aspect of the present invention, since the fluorescent dye for producing template data is contained in the polymer and the image analyzing method comprises the steps of causing the polymer to contain the specific binding substance, spot-like dropping the polymer onto the substrate to form a plurality of spots, hybridizing the substance derived from a living organism and labeled with a fluorescent dye with the specific binding substance, irradiating the plurality of spots with a stimulating ray having a wavelength capable of efficiently stimulating the fluorescent dye labeling the substance derived from a living organism, thereby stimulating the fluorescent dye, photoelectrically detecting fluorescence emission released from the fluorescent dye to produce image data, irradiating the plurality of spots with a stimulating ray having a wavelength capable of efficiently stimulating the fluorescent dye for producing template data, thereby stimulating the fluorescent dye for producing template data, photoelectrically detecting fluorescence emission released from the fluorescent dye for producing template data, producing the template data, producing the template for defining regions of interest to be quantified based on the thus produced template data, and effecting quantitative analysis based on the template, it is sufficient to cause the polymer having high viscosity and used for forming the spots with high density to contain the specific binding substance and spot-like drop the polymer onto the substrate, thereby forming a plurality of spots and, therefore, it is possible to produce template data with a simple operation, produce a template for defining regions of interest to be quantified based on the thus produced template data, define the regions of interest to be quantified based on the template in a desired manner, and effect quantitative analysis with extremely high accuracy.

In another preferred aspect of the present invention, the image analyzing method comprises the steps of dropping a solution containing the fluorescent dye for producing template data onto a substrate using a spotter to form a plurality of spots, irradiating the plurality of spots with a stimulating ray having a wavelength capable of efficiently stimulating the fluorescent dye for producing template data, thereby stimulating the fluorescent dye for producing template data, photoelectrically detecting fluorescence emission released from the fluorescent dye for producing template data, producing the template data, producing a template for defining regions of interest to be quantified based on the thus produced template data, dropping a solution containing the specific binding substance using the spotter onto another substrate to form a plurality of spots, hybridizing the substance derived from a living organism and labeled with a fluorescent dye with the specific binding substance, irradiating the plurality of spots with a stimulating ray having a wavelength capable of efficiently stimulating the fluorescent dye labeling the substance derived from a living organism, thereby stimulating the fluorescent dye, photoelectrically detecting fluorescence emission released from the fluorescent dye to produce image data, defining regions of interest to be quantified in the image data, and effecting quantitative analysis.

According to this preferred aspect of the present invention, since the image analyzing method comprises the steps of dropping a solution containing the fluorescent dye for producing template data onto a substrate using a spotter to form a plurality of spots, irradiating the plurality of spots with a stimulating ray having a wavelength capable of efficiently stimulating the fluorescent dye for producing template data, thereby stimulating the fluorescent dye for producing template data, photoelectrically detecting fluorescence emission released from the fluorescent dye for producing template data, producing the template data, producing the template for defining regions of interest to be quantified based on the thus produced template data, dropping a solution containing the specific binding substance using the spotter onto another substrate to form a plurality of spots, hybridizing the substance derived from a living organism and labeled with a fluorescent dye with the specific binding substance, irradiating the plurality of spots with a stimulating ray having a wavelength capable of efficiently stimulating the fluorescent dye labeling the substance derived from a living organism, thereby stimulating the fluorescent dye, photoelectrically detecting fluorescence emission released from the fluorescent dye to produce image data, defining regions of interest to be quantified in the image data, and effecting quantitative analysis, even if the spotter produces spotting error, it is possible to define regions of interest to be quantified in a desired manner and accurately effect quantitative analysis.

In another preferred aspect of the present invention, the image analyzing method comprises the steps of spot-like dropping the specific binding substance onto the substrate to form a plurality of spots, irradiating the plurality of spots with light, photoelectrically detecting light scattered by the plurality of spots to produce template data, and producing a template for defining regions of interest to be quantified based on the thus produced template data.

According to this preferred aspect of the present invention, since the image analyzing method comprises the steps of spot-like dropping the specific binding substance onto the substrate to form a plurality of spots, irradiating the plurality of spots with light, photoelectrically detecting light scattered by the plurality of spots to produce template data, and producing a template for defining regions of interest to be quantified based on the thus produced template data, template data can be produced only by spot-like dropping the specific binding substance onto the substrate to form a plurality of spots and irradiating the plurality of spots with light and photoelectrically detecting light scattered by the plurality of spots, and it is therefore possible to produce a template for defining regions of interest to be quantified in a desired manner based on the template data and accurately effect quantitative analysis.

In a further preferred aspect of the present invention, the image analyzing method comprises the steps of spot-like dropping the specific binding substance onto the substrate to form a plurality of spots, hybridizing the substance derived from a living organism and labeled with a fluorescent dye with the specific binding substance, irradiating the plurality of spots with a stimulating ray having a wavelength capable of efficiently stimulating the fluorescent dye, photoelectrically detecting light scattered by the plurality of spots to produce template data, producing a template for defining regions of interest to be quantified based on the thus produced template data, irradiating the plurality of spots with a stimulating ray having a wavelength capable of efficiently stimulating the fluorescent dye, thereby stimulating the fluorescent dye labeling the substance derived from a living organism, photoelectrically detecting fluorescence emission released from the fluorescent dye to produce image data, defining regions of interest to be quantified in the image data based on the template, and effecting quantitative analysis.

According to this preferred aspect of the present invention, since the image analyzing method comprises the steps of spot-like dropping the specific binding substance onto the substrate to form a plurality of spots, hybridizing the substance derived from a living organism and labeled with a fluorescent dye with the specific binding substance, irradiating the plurality of spots with a stimulating ray having a wavelength capable of efficiently stimulating the fluorescent dye, photoelectrically detecting light scattered by the plurality of spots to produce template data, producing the template for defining regions of interest to be quantified based on the thus produced template data, irradiating the plurality of spots with a stimulating ray having a wavelength capable of efficiently stimulating the fluorescent dye, thereby stimulating the fluorescent dye labeling the substance derived from a living organism, photoelectrically detecting fluorescence emission released from the fluorescent dye to produce image data, defining regions of interest to be quantified in the image data based on the template, and effecting quantitative analysis, template data can be produced only by spot-like dropping the specific binding substance onto the substrate to form a plurality of spots and irradiating the plurality of spots with light and photoelectrically detecting light scattered by the plurality of spots, and it is therefore possible to produce a template for defining regions of interest to be quantified in a desired manner based on the template data and accurately effect quantitative analysis.

In another preferred aspect of the present invention, the image analyzing method comprises the steps of spot-like dropping the specific binding substance onto the substrate to form a plurality of spots, hybridizing the substance derived from a living organism and labeled with a fluorescent dye with the specific binding substance, irradiating the plurality of spots with a stimulating ray having a wavelength capable of efficiently stimulating the fluorescent dye, thereby stimulating the fluorescent dye, photoelectrically detecting fluorescence emission released from the fluorescent dye to produce image data, irradiating the plurality of spots with a stimulating ray having a wavelength capable of efficiently stimulating the fluorescent dye, photoelectrically detecting light scattered by the plurality of spots to produce template data, producing a template for defining regions of interest to be quantified based on the thus produced template data, defining regions of interest to be quantified in the image data based on the template, and effecting quantitative analysis.

According to this preferred aspect of the present invention, since the image analyzing method comprises the steps of spot-like dropping the specific binding substance onto the substrate to form a plurality of spots, hybridizing the substance derived from a living organism and labeled with a fluorescent dye with the specific binding substance, irradiating the plurality of spots with a stimulating ray having a wavelength capable of efficiently stimulating the fluorescent dye, thereby stimulating the fluorescent dye, photoelectrically detecting fluorescence emission released from the fluorescent dye to produce image data, irradiating the plurality of spots with a stimulating ray having a wavelength capable of efficiently stimulating the fluorescent dye, photoelectrically detecting light scattered by the plurality of spots to produce template data, producing the template for defining regions of interest to be quantified based on the thus produced template data, defining regions of interest to be quantified in the image data based on the template, and effecting quantitative analysis, template data can be produced only by spot-like dropping the specific binding substance onto the substrate to form a plurality of spots and irradiating the plurality of spots with light and photoelectrically detecting light scattered by the plurality of spots, and it is therefore possible to produce a template for defining regions of interest to be quantified in a desired manner based on the template data and accurately effect quantitative analysis.

The above and other objects of the present invention can be also accomplished by an image analyzing apparatus comprising at least two stimulating ray sources, a light detector and an image reading apparatus for producing image data by photoelectrically detecting fluorescence emission by the light detector, the image analyzing apparatus further comprising template producing means for producing a template based on template data produced by photoelectrically detecting by the light detector of the image reading apparatus all of the spots of a specific binding substance formed on a substrate by spot-like dropping the specific binding substance and defining regions of interest to be quantified based on the template, and quantitative analyzing means for defining regions of interest to be quantified in the image data based on the template produced by the template producing means and effecting quantitative analysis.

According to this aspect of the present invention, since the image analyzing apparatus comprises at least two stimulating ray sources, a light detector and an image reading apparatus for producing image data by photoelectrically detecting fluorescence emission by the light detector, the image analyzing apparatus further comprising template producing means for producing a template based on template data produced by photoelectrically detecting by the light detector of the image recording apparatus all of the spots of a specific binding substance formed on a substrate by spot-like dropping the specific binding substance and defining regions of interest to be quantified based on the template, and quantitative analyzing means for defining regions of interest to be quantified in the image data based on the template produced by the template producing means and effecting quantitative analysis, even if a specific binding substance cannot be spotted onto a desired position on the surface of a substrate such as a slide glass plate, a membrane filter or the like due to spotting error of the spotter, it is still possible to determine the positions of all spots and, therefore, it is possible to produce a template for defining regions of interest to be quantified in a desired manner and accurately effect quantitative analysis based on the template.

In a preferred aspect of the present invention, the image reading apparatus is constituted so as to irradiate a plurality of spots formed by spot-like dropping a fluorescent dye for producing template data capable of being efficiently stimulated by a stimulating ray having a different wavelength from that of a stimulating ray capable of efficiently stimulating a fluorescent dye labeling a target substance derived from a living organism onto the substrate together with the specific binding substance with a stimulating ray emitted from one of the at least two stimulating ray sources to stimulate the fluorescent dye and produce template data by photoelectrically detecting fluorescence emission released from the fluorescent dye for producing template data by the light detector.

According to this preferred aspect of the present invention, since the image reading apparatus is constituted so as to irradiate a plurality of spots formed by spot-like dropping a fluorescent dye for producing template data capable of being efficiently stimulated by a stimulating ray having a different wavelength from that of a stimulating ray capable of efficiently stimulating a fluorescent dye labeling a target substance derived from a living organism onto the substrate together with the specific binding substance with a stimulating ray emitted from one of the at least two stimulating ray sources to stimulate the fluorescent dye and produce template data by photoelectrically detecting fluorescence emission released from the fluorescent dye for producing template data by the light detector, it is possible to accurately photoelectrically detect all of the spots formed by dropping a specific binding substance onto the substrate by the image reading apparatus to produce template data, to produce a template for defining regions of interest to be quantified based on the thus produced template data and to effect quantitative analysis based on the template, and it is therefore possible to produce a template for defining regions of interest to be quantified in a desired manner and accurately effect quantitative analysis based on the template.

In a further preferred aspect of the present invention, the image reading apparatus is constituted so as to irradiate a specimen obtained by spot-like dropping the fluorescent dye for producing template data onto the substrate together with the specific binding substance to form the plurality of spots and hybridizing the substance derived from a living organism and labeled with a fluorescent dye with the specific binding substance with a stimulating ray having a wavelength capable of efficiently stimulating the fluorescent dye for producing template data and emitted from one of the at least two stimulating ray sources to stimulate the fluorescent dye for producing template data, irradiate the fluorescent dye labeling the substance derived from a living organism with a stimulating ray having a wavelength capable of efficiently stimulating the fluorescent dye and emitted from the other of the at least two stimulating ray sources to stimulate the fluorescent dye, produce template data by photoelectrically detecting fluorescence emission released from the fluorescent dye for producing template data by the light detector, and produce image data by photoelectrically detecting fluorescence emission released from the fluorescent dye labeling the substance derived from a living organism, the template producing means is constituted so as to produce the template based on the template data, and the quantitative analyzing means is constituted so as to effect template fitting between the template produced by the template producing means and the image data, thereby defining regions of interest in the image data and effecting quantitative analysis.

According to this preferred aspect of the present invention, since the image reading apparatus is constituted so as to irradiate a specimen obtained by spot-like dropping the fluorescent dye for producing template data onto the substrate together with the specific binding substance to form the plurality of spots and hybridizing the substance derived from a living organism and labeled with a fluorescent dye with the specific binding substance with a stimulating ray having a wavelength capable of efficiently stimulating the fluorescent dye for producing template data and emitted from one of the at least two stimulating ray sources to stimulate the fluorescent dye for producing template data, irradiate the fluorescent dye labeling the substance derived from a living organism with a stimulating ray having a wavelength capable of efficiently stimulating the fluorescent dye and emitted from the other of the at least two stimulating ray sources to stimulate the fluorescent dye, produce template data by photoelectrically detecting fluorescence emission released from the fluorescent dye for producing template data by the light detector, and produce image data by photoelectrically detecting fluorescence emission released from the fluorescent dye labeling the substance derived from a living organism, the template producing means is constituted so as to produce the template based on the template data, and the quantitative analyzing means is constituted so as to effect template fitting between the template produced by the template producing means and the image data, thereby defining regions of interest in the image data and effecting quantitative analysis, all fluorescence emission released from fluorescent dye labeling the substance derived from a living organism and photoelectrically detected by the light detector of the image reading apparatus is released from spots included in the template and it is therefore possible to define regions of interest to be quantified in the image data in a desired manner by the quantitative analyzing means and effect quantitative analysis with an extremely high accuracy.

In another preferred aspect of the present invention, the image reading apparatus is constituted so as to irradiate a specimen including a plurality spots formed by spot-like dropping the fluorescent dye for producing template data onto the substrate together with the specific binding substance with a stimulating ray having a wavelength capable of efficiently stimulating the fluorescent dye for producing template data and emitted from one of the at least two stimulating ray sources to stimulate the fluorescent dye for producing template data, produce template data by photoelectrically detecting fluorescence emission released from the fluorescent dye by the light detector, further irradiate a specimen obtained by hybridizing the substance derived from a living organism and labeled with a fluorescent dye with the specific binding substance forming the plurality of spots on the substrate with a stimulating ray having a wavelength capable of efficiently stimulating the fluorescent dye and emitted from the other of the at least two stimulating ray sources to stimulate the fluorescent dye, and produce image data by further photoelectrically detecting fluorescence emission released from the fluorescent dye labeling the substance derived from a living organism by the light detector, the template producing means is constituted so as to produce the template based on the template data, and the quantitative analyzing means is constituted so as to effect template fitting between the template produced by the template producing means and the image data, thereby defining regions of interest in the image data and effecting quantitative analysis.

According to this preferred aspect of the present invention, since the image reading apparatus is constituted so as to irradiate a specimen including a plurality spots formed by spot-like dropping the fluorescent dye for producing template data onto the substrate together with the specific binding substance with a stimulating ray having a wavelength capable of efficiently stimulating the fluorescent dye for producing template data and emitted from one of the at least two stimulating ray sources to stimulate the fluorescent dye for producing template data, produce template data by photoelectrically detecting fluorescence emission released from the fluorescent dye by the light detector, further irradiate a specimen obtained by hybridizing the substance derived from a living organism and labeled with a fluorescent dye with the specific binding substance forming the plurality of spots on the substrate with a stimulating ray having a wavelength capable of efficiently stimulating the fluorescent dye and emitted from the other of the at least two stimulating ray sources to stimulate the fluorescent dye, and produce image data by further photoelectrically detecting fluorescence emission released from the fluorescent dye labeling the substance derived from a living organism by the light detector, the template producing means is constituted so as to produce the template based on the template data, and the quantitative analyzing means is constituted so as to effect template fitting between the template produced by the template producing means and the image data, thereby defining regions of interest in the image data and effecting quantitative analysis, all fluorescence emission released from fluorescent dye labeling the substance derived from a living organism and photoelectrically detected by the light detector of the image reading apparatus is released from spots included in the template and it is therefore possible to define regions of interest to be quantified in the image data in a desired manner by the quantitative analyzing means and effect quantitative analysis with an extremely high accuracy.

In another preferred aspect of the present invention, the image reading apparatus is constituted so as to irradiate a specimen including a plurality of spots formed by spot-like dropping a polymer containing the specific binding substance and the fluorescent dye for producing template data onto the substrate with a stimulating ray having a wavelength capable of efficiently stimulating the fluorescent dye for producing template data and emitted from one of the at least two stimulating ray sources to stimulate the fluorescent dye for producing template data, and produce template data by photoelectrically detecting fluorescence emission released from the fluorescent dye for producing template data by the light detector.

According to this preferred aspect of the present invention, since the image reading apparatus is constituted so as to irradiate a specimen including a plurality of spots formed by spot-like dropping a polymer containing the specific binding substance and the fluorescent dye for producing template data onto the substrate with a stimulating ray having a wavelength capable of efficiently stimulating the fluorescent dye for producing template data and emitted from one of the at least two stimulating ray sources to stimulate the fluorescent dye for producing template data, and produce template data by photoelectrically detecting fluorescence emission released from the fluorescent dye for producing template data by the light detector, it is sufficient to cause the polymer having high viscosity and used for forming the spots with high density to contain the specific binding substance and spot-like drop the polymer onto the substrate, thereby forming a plurality of spots and, therefore, it is possible for the image reading apparatus to produce template data with a simple operation and it is possible for the quantitative analyzing means to define the regions of interest to be quantified based on the template produced by the template data producing means in a desired manner, and effect quantitative analysis with extremely high accuracy.

In another preferred aspect of the present invention, the image analyzing apparatus further comprises data storing means for storing data produced by the image reading apparatus and the image reading apparatus is constituted so as to irradiate a plurality of spots formed by spot-like dropping a solution containing a fluorescent dye for producing template data onto a substrate using a spotter with a stimulating ray having a wavelength capable of efficiently stimulating the fluorescent dye for producing template data and emitted from one of the at least two stimulating ray sources to stimulate the fluorescent dye for producing template data, photoelectrically detect fluorescence emission released from the fluorescent dye for producing template data by the light detector, thereby producing template data and storing them in the data storing means, irradiate a specimen including a plurality of spots formed by spot-like dropping a solution containing the specific binding substance onto another substrate using the spotter and hybridizing the substance derived from a living organism labeled with a fluorescent dye with the specific binding substance with a stimulating ray having a wavelength capable of efficiently stimulating the fluorescent dye and emitted from the other of the at least two stimulating ray sources to stimulate the fluorescent dye, photoelectrically detect fluorescence emission released from the fluorescent dye by the light detector, thereby producing image data, the template producing means is constituted so as to produce a template based on the template data stored in the data storing means, and the quantitative analyzing means is constituted so as to effect template fitting between the template produced by the template producing means and the image data, thereby defining regions of interest in the image data and effect quantitative analysis.

According to this preferred aspect of the present invention, since the image analyzing apparatus further comprises data storing means for storing data produced by the image reading apparatus and the image reading apparatus is constituted so as to irradiate a plurality of spots formed by spot-like dropping a solution containing a fluorescent dye for producing template data onto a substrate using a spotter with a stimulating ray having a wavelength capable of efficiently stimulating the fluorescent dye for producing template data and emitted from one of the at least two stimulating ray sources to stimulate the fluorescent dye for producing template data, photoelectrically detect fluorescence emission released from the fluorescent dye for producing template data by the light detector, thereby producing template data and storing them in the data storing means, irradiate a specimen including a plurality of spots formed by spot-like dropping a solution containing the specific binding substance onto another substrate using the spotter and hybridizing the substance derived from a living organism labeled with a fluorescent dye with the specific binding substance with a stimulating ray having a wavelength capable of efficiently stimulating the fluorescent dye and emitted from the other of the at least two stimulating ray sources to stimulate the fluorescent dye, photoelectrically detect fluorescence emission released from the fluorescent dye by the light detector, thereby producing image data, the template producing means is constituted so as to produce a template based on the template data stored in the data storing means, and the quantitative analyzing means is constituted so as to effect template fitting between the template produced by the template producing means and the image data, thereby defining regions of interest in the image data and effect quantitative analysis, even if the spotter produces spotting error, it is still possible for the image reading apparatus to produce the template based on the template data produced by the image reading apparatus and it is possible for the quantitative analyzing means to define regions of interest to be quantified based on the thus produced template in a desired manner and effect quantitative analysis with extremely high accuracy.

In another preferred aspect of the present invention, the image reading apparatus is constituted so as to irradiate a plurality of spots formed by spot-like dropping the specific binding substance onto the substrate with light and photoelectirically detect light scattered by the plurality of spots, thereby producing template data, the template producing means is constituted so as to produce a template based on the template data, and the quantitative analyzing means is constituted so as to define regions of interest to be quantified based on the template and effect quantitative analysis.

According to this preferred aspect of the present invention, since the image reading apparatus is constituted so as to irradiate a plurality of spots formed by spot-like dropping the specific binding substance onto the substrate with light and photoelectirically detect light scattered by the plurality of spots, thereby producing template data, the template producing means is constituted so as to produce a template based on the template data, and the quantitative analyzing means is constituted so as to define regions of interest to be quantified based on the template and effect quantitative analysis, the image reading apparatus can produce template data only by spot-like dropping the specific binding substance onto the substrate to form a plurality of spots, irradiating the plurality of spots with light and photoelectrically detecting light scattered by the plurality of spots, and it is therefore possible for the quantitative analyzing means to define regions of interest to be quantified in a desired manner based on the template produced by the template data producing means based on the template data and accurately effect quantitative analysis.

In a further preferred aspect of the present invention, the image reading apparatus further comprises a filter detachably mounted on a front surface for cutting a light component of a wavelength of a stimulating ray and is constituted so as to irradiate, while the filter is detached, a specimen including a plurality of spots formed by spot-like dropping the specific binding substance onto the substrate and hybridizing the substance derived from a living organism and labeled with a fluorescent dye with the specific binding substance with a stimulating ray having a wavelength capable of effectively stimulating the fluorescent dye, photoelectrically detect light of the stimulating ray scattered by the plurality of spots by the light detector, thereby producing template data, and is also constituted so as to irradiate, while the filter is attached, the plurality of spots with a stimulating ray having a wavelength capable of effectively stimulating the fluorescent dye, thereby stimulating the fluorescent dye, photoelectrically detect fluorescence emission released from the fluorescent dye, thereby producing image data by the light detector, the template data producing means is constituted so as to produce a template based on the template data, and the quantitative analyzing means is constituted so as to effect template fitting between the template and the image data, thereby defining regions of interest to be quantified in the image data and effecting quantitative analysis.

According to this preferred aspect of the present invention, since the image reading apparatus further comprises a filter detachably mounted on a front surface for cutting a light component of a wavelength of a stimulating ray and is constituted so as to irradiate, while the filter is detached, a specimen including a plurality of spots formed by spot-like dropping the specific binding substance onto the substrate and hybridizing the substance derived from a living organism and labeled with a fluorescent dye with the specific binding substance with a stimulating ray having a wavelength capable of effectively stimulating the fluorescent dye, photoelectrically detect light of the stimulating ray scattered by the plurality of spots by the light detector, thereby producing template data, and is also constituted so as to irradiate, while the filter is attached, the plurality of spots with a stimulating ray having a wavelength capable of effectively stimulating the fluorescent dye, thereby stimulating the fluorescent dye, photoelectrically detect fluorescence emission released from the fluorescent dye, thereby producing image data by the light detector, the template data producing means is constituted so as to produce a template based on the template data, and the quantitative analyzing means is constituted so as to effect template fitting between the template and the image data, thereby defining regions of interest to be quantified in the image data and effecting quantitative analysis, template data can be simply produced without using a special fluorescent dye and it is possible for the template producing means to produce a template based on the template data and for the quantitative analyzing means to define regions of interest to be quantified in the image data and accurately effect quantitative analysis.

The above and other objects and features of the present invention will become apparent from the following description made with reference to the accompanying drawings.

### BRIEF DESCRIPTION OF THE DRAWINGS

FIG. 1 is a schematic perspective view showing an image reading apparatus incorporated in an image analyzing system which is a preferred embodiment of the present invention.

FIG. 2 is a schematic perspective view showing a DNA micro-array carrying a fluorescent image to be analyzed by an image analyzing system which is a preferred embodiment of the present invention.

FIG. 3 is a schematic front view showing a confocal switching member.

FIG. 4 is a schematic perspective view showing the details of a main scanning mechanism that is part of a scanning mechanism of a sample stage.

FIG. 5 is a block diagram of a control system, an input system and a drive system of the image reading apparatus shown in FIG. 1 and incorporated in an image analyzing system which is a preferred embodiment of the present invention.

FIG. 6 is a block diagram of an image analyzing apparatus incorporated in an image analyzing system which is a preferred embodiment of the present invention.

FIG. 7 is a block diagram of a data processing means of an image analyzing apparatus incorporated in an image analyzing system which is a preferred embodiment of the present invention.

FIG. 8 is a block diagram of a quantitative analysis effecting means provided in a data processing means of an image analyzing apparatus incorporated in an image analyzing system which is a preferred embodiment of the present invention.

### DESCRIPTION OF THE PREFERRED EMBODIMENT

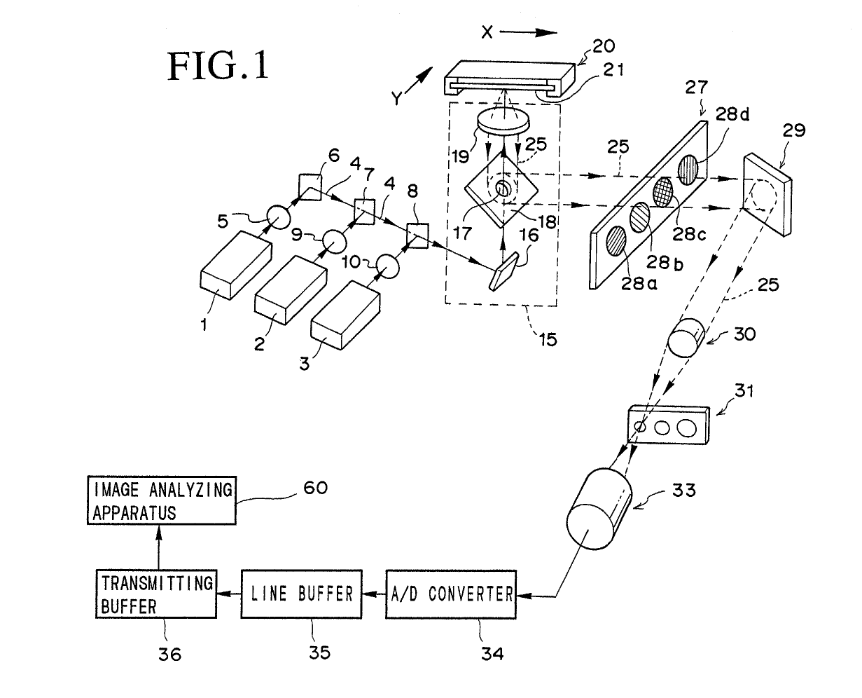

FIG. 1 is a schematic perspective view showing an image reading apparatus incorporated in an image analyzing system which is a preferred embodiment of the present invention.

As shown in FIG. 1, an image reading apparatus incorporated in an image analyzing system according to this embodiment includes a first laser stimulating ray source 1 for emitting a laser beam having a wavelength of 640 nm, a second laser stimulating ray source 2 for emitting a laser beam having a wavelength of 532 nm and a third laser stimulating ray source 3 for emitting a laser beam having a wavelength of 473 nm. In this embodiment, the first laser stimulating ray source 1 constituted by a semiconductor laser beam source and the second laser stimulating ray source 2 and the third laser stimulating ray source 3 are constituted by a second harmonic generation element.

A laser beam 4 emitted from the first laser stimulating source 1 passes through a collimator lens 5, thereby being made a parallel beam, and is reflected by a mirror 6. A first dichroic mirror 7 for transmitting light having a wavelength of 640 nm but reflecting light having a wavelength of 532 nm and a second dichroic mirror 8 for transmitting light having a wavelength equal to and longer than 532 nm but reflecting light having a wavelength of 473 nm are provided in an optical path of the laser beam 4 reflected by the mirror 6. The laser beam 4 emitted from the first laser stimulating ray source 1 passes through the first dichroic mirror 7 and the second dichroic mirror 8 and enters an optical unit 15.

On the other hand, the laser beam 4 emitted from the second laser stimulating ray source 2 passes through a collimator lens 9, thereby being made a parallel beam, and is reflected by the first dichroic mirror 6, thereby changing its direction by 90 degrees. The laser beam 4 then passes through the second dichroic mirror 8 and enters the optical unit 15.

Further, the laser beam 4 emitted from the third laser stimulating ray source 3 passes through a collimator lens 10, thereby being made a parallel beam, and is reflected by the second dichroic mirror 8, thereby changing its direction by 90 degrees.

The optical unit 15 includes a mirror 16, a perforated mirror 18 whose center portion is formed with a hole 17 and a lens 19. The laser beam 4 entering the optical unit 15 is reflected by the mirror 16 and passes through the hole 17 formed in the perforated mirror 18 and the lens 19, thereby entering a sample carrier 21 set on a sample stage 20. The sample stage 20 is constituted so as to be movable by a scanning mechanism (not shown) in the X direction and the Y direction in FIG. 1.

The image reading apparatus according to this embodiment is constituted so as to produce image data for biochemical analysis by scanning a DNA micro-array including a slide glass plate on which a number of spots of a specimen selectively labeled with a fluorescent dye are formed as a substrate with a laser beam 4 to stimulate the fluorescent dye and photoelectrically detecting fluorescence emission released from the fluorescent dye and to also produce image data for biochemical analysis by scanning a fluorescence sample including a transfer support containing denatured DNA fragments selectively labeled with a fluorescent dye as a substrate with a laser beam 4 to stimulate the fluorescent dye and photoelectrically detecting fluorescence emission released from the fluorescent dye. The image reading apparatus according to this embodiment is further constituted so as to produce image data for biochemical analysis by scanning a stimulable phosphor layer of a stimulable phosphor sheet in which locational information of a radioactive labeling substance by closely contacting a substrate such as a membrane filter having a number of spots of a specimen selectively labeled with a radioactive labeling substance and the stimulable phosphor sheet formed with the stimulable phosphor layer containing a stimulable phosphor to expose the stimulable phosphor layer with the radioactive labeling substance with a laser beam 4 to excite the stimulable phosphor and photoelectrically detecting stimulated emission released from the stimulable phosphor.

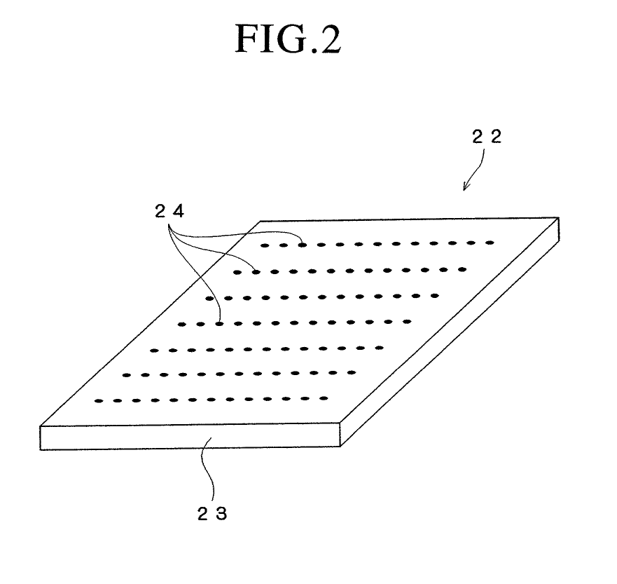

FIG. 2 is a schematic perspective view showing a DNA micro-array carrying a fluorescent image to be analyzed by an image analyzing system which is a preferred embodiment of the present invention.

As shown in FIG. 2, the DNA micro-array 22 includes a number of spots 24 formed on a slide glass plate 23.

A number of spots 24 are formed on the slide glass plate 23 in the following manner, for example.

First, specimen solutions containing two or more kinds of cDNA probes mixed with a fluorescent dye, Fluor-X (registered trademark) are spot-like dropped onto the slide glass plate 23.

On the other hand, a specimen of RNA is extracted from biological cells, and mRNA having poly A at 3′ terminal is extracted from the RNA. Then, cDNA is synthesized from the thus extracted mRNA having poly A at 3′ terminal in the presence of a labeling substance Cy3 (registered trademark), to prepare first target DNA labeled with Cy3.

Further, a specimen of RNA is extracted from biological cells, and mRNA having poly A at 3′ terminal is extracted from the RNA. Then, cDNA is synthesized from the thus extracted mRNA having poly A at 3′ terminal in the presence of a labeling substance Cy5 (registered trademark), to prepare second target DNA labeled with Cy5.

The thus prepared first target DNA and second target DNA are mixed and the thus mixed solution is gently loaded onto the surface of the slide glass plate 23 on which cDNAs, specific binding substances, are spotted, and then hybridization is performed.

FIG. 2 is a schematic perspective view of a DNA micro-array 22 prepared by forming a number of spots 24 in this manner.

On the other hand, an electrophoresis image of denatured DNA fragments labeled with a fluorescent dye is, for example, recorded in a transfer support in the following manner.

First, a plurality of DNA fragments containing a specific gene are separated and distributed on a gel support medium by means of electrophoresis and are denatured by alkali processing to form single-stranded DNA.

Then, according to the known Southern blotting method, the gel support and a transfer support are stacked to transfer at least a part of the denatured DNA fragments onto the transfer support and the transferred DNA fragments are fixed on the transfer support by heating and irradiating with an ultraviolet ray.

Further, probes prepared by labeling DNA or RNA with fluorescent dye, which is complementary to the DNA containing the specific gene, and the denatured DNA fragments on the transfer support are hybridized by heating to form double-stranded DNA fragments or combined DNA and RNA. Then, DNA or RNA which is complementary to the DNA containing DNA of the specific gene is labeled with a fluorescent dye such as Fluorescein, Rhodamine or Cy-5 to prepare the probes. Since the denatured DNA fragments are fixed on the transfer support at this time, only the DNA fragments which are complimentary to the probe DNA or probe RNA are hybridized to acquire the fluorescently labeled probe. Then, the probes which have not formed hybrids are removed by washing with a proper solution and only the DNA fragments having a specific gene form hybrids with the fluorescently labeled DNA or RNA on the transfer support to be fluorescently labeled. The thus obtained transfer support records an electrophoresis image of the denatured DNA labeled with fluorescent dye.

Further, locational information regarding a radioactive labeling substance is recorded in a stimulable phosphor layer formed on the stimulable sheet in following manner, for example.

The surface of a substrate such as a membrane filter is pretreated and then cDNAs which are specific binding substances, each of which has a known base sequence and is different from the others, are spotted onto predetermined positions on the surface of the substrate such as a membrane filter using a spotter device.

On the other hand, a specimen of RNA is extracted from biological cells, and mRNA having poly A at 3′ terminal is extracted from the RNA. Then, cDNA is synthesized from the thus extracted mRNA having poly A at 3′ terminal in the presence of a radioactive labeling substance to prepare probe DNA labeled with the radioactive labeling substance.

A solution of the thus obtained probe DNA labeled with the radioactive labeling substance is prepared, and is gently loaded onto the surface of the substrate such as a membrane filter on which cDNAs, specific binding substances, are spotted, and then hybridization is performed.

A stimulable phosphor layer formed on a stimulable phosphor sheet is then superimposed on the surface of the substrate such as a membrane filter containing a hybridized specimen and they are held for a certain period of time, whereby at least a part of radiation released from the radioactive labeling substance on the substrate such as a membrane filter is absorbed in the stimulable phosphor layer formed on the stimulable phosphor sheet and locational information of the radioactive labeling substance is recorded in the stimulable phosphor layer.

When the laser beam 4 is impinged on the sample 22 from the optical unit 15, a fluorescent substance is excited by the laser beam 4 to release fluorescence emission in the case where the sample 22 is a micro-array or a fluorescence sample. On the other hand, in the case where the sample 22 is a stimulable phosphor sheet, stimulable phosphors contained in the stimulable phosphor sheet are excited by the laser beam 4 to release stimulated emission.

The fluorescence emission or the stimulated emission 25 released from the sample 22 is made into a parallel beam by the lens 19 of the optical unit 15 and reflected by the perforated mirror 18, thereby entering one of four filters 28a, 28b, 28c and 28d of a filter unit 27.

The filter unit 27 is constituted to be laterally movable in FIG. 1 by a motor (not shown) so that a predetermined one of the filters 28a, 28b, 28c and 28d is located in the optical path of the fluorescence emission or the stimulated emission 25 depending upon the kind of the laser stimulating ray source to be used.

The filter 28a is used for reading fluorescence emission released from fluorescent substance contained in the sample 22 upon being excited using the first laser stimulating ray source 1 and has a property to cut off light having a wavelength of 640 nm but transmit light having a wavelength longer than 640 nm.

The filter 28b is used for reading fluorescence emission released from fluorescent substance contained in the sample 22 upon being excited using the second laser stimulating ray source 2 and has a property to cut off light having a wavelength of 532 nm but transmit light having a wavelength longer than 532 nm.

The filter 28c is used for reading fluorescence emission released from fluorescent substance contained in the sample 22 upon being excited using the third laser stimulating ray source 3 and has a property to cut off light having a wavelength of 473 nm but transmit light having a wavelength longer than 473 nm.

The filter 28d is used in the case where the sample 22 is a stimulable phosphor sheet for reading stimulated emission released from stimulable phosphor contained in the stimulable phosphor sheet upon being excited using the first laser stimulating ray source 1 and has a property to transmit only light having a wavelength corresponding to that of stimulated emission emitted from stimulable phosphor but cut off light having a wavelength of 640 nm.

Therefore, in accordance with the kind of a stimulating ray source to be used, namely, depending upon whether the image to be read is a fluorescent image or an image regarding locational information of a radioactive labeling substance and the kind of fluorescent substance labeling a specimen, one of these filters 28a, 28b, 28c, 28d is selectively used, thereby cutting light of wavelengths which cause noise.

After fluorescence emission or stimulated emission 25 passes through one of the filters 28a, 28b, 28c, 28d, whereby light of a predetermined wavelength region is cut, the fluorescence emission or the stimulated emission 25 advances to a mirror 29 and is reflected thereby to be focused by a lens 30.

The lens 19 and the lens 30 constitute a confocal optical system. The reason for employing a confocal optical system is to enable fluorescence emission emitted from a minute spot formed on a slide glass plate 23 to be read with a high S/N ratio when the sample 22 is a micro-array including the slide glass plate 23 as a substrate.

A confocal switching member 31 is provided at the focal point of the lens 30.

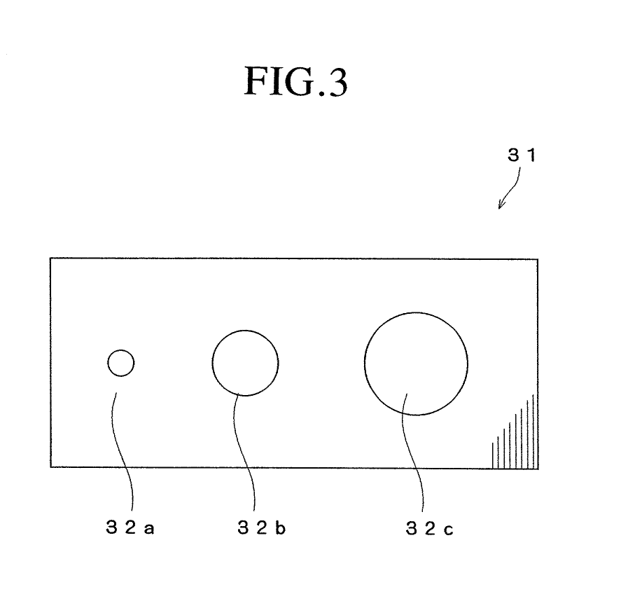

FIG. 3 is a schematic front view showing the confocal switching member 31.

As shown in FIG. 3, the confocal switching member 31 is formed plate-like and with three pinholes 32a, 32b, 32c.

The pinhole 32a having the smallest diameter is located in a light path of fluorescence emission emitted from the micro-array when the sample is a micro-array including a slide glass palte as a substrate and the pinhole 32c having the largest diameter is located in a light path of fluorescence emission emitted from a transfer support when the sample is a fluorescence sample including a transfer support as a substrate.

Further, the pinhole 32b having an intermediate diameter is located in a light path of a stimulated emission released from a stimulable phosphor layer when the sample is a stimulable phosphor sheet.

In this manner, the confocal switching member 31 is provided at the focal point of the lens 30 and the pinhole 32a having the smallest diameter is located in the light path of fluorescence emission when the sample 22 is a micro-array including a slide glass plate 23 as a substrate. This is because when the sample 22 is a micro-array including a slide glass plate 23 as a substrate, fluorescence emission is emitted from the surface of the slide glass plate 23 when the fluorescent dye is excited with the laser beam 4 and the depth of the light emitting points in the slide glass plate is substantially constant, so that it is preferable to use a confocal optical system to focus an image on the pinhole 32a having the smallest diameter for improving the SIN ratio.

On the other hand, the pinhole 32c is located in the light path of fluorescence emission when the sample 22 is a fluorescence sample including a transfer support as a substrate. This is because when the sample 22 is a fluorescence sample including a transfer support as a substrate, the positions of the light emitting points fluctuate in the depth direction when the fluorescent dye is excited with the laser beam 4 because the fluorescent substance are distributed in the depth direction of the transfer support, so that it is impossible to focus an image on a pinhole having a small diameter even when a confocal optical system is used, and a fluorescent light emitted from the specimen is cut if a pinhole having a small diameter is used, whereby signals having a sufficient intensity cannot be obtained and, therefore, it is necessary to use the pinhole 32c having the largest diameter.

Further, in the case where the sample 22 is a stimulable phosphor sheet, the pinhole 32b having an intermediate diameter is located in a light path of a stimulated emission. This is because when the sample 22 is a stimulable phosphor sheet, the positions of the light emitting points fluctuate in the depth direction when a stimulable phosphor contained in the stimulable phosphor layer is excited with the laser beam 4 because the light emitting points of a stimulated emission are distributed in the depth direction of the stimulable phosphor layer, so that it is impossible to focus an image on a pinhole having a small diameter even when a confocal optical system is used, and the stimulated emission emitted from the specimen is cut if a pinhole having a small diameter is used, whereby signals having a sufficient intensity cannot be obtained by photoelectrically detecting the stimulated emission but the distribution of the light emitting points in the depth direction and the fluctuation in positions of the light emitting points in the depth direction are no so great as those for reading a fluorescent image carried in the transfer support or the gel support and, therefore, it is preferable to employ the pinhole 32b having an intermediate diameter.

The fluorescence emission or stimulated emission 25 passing through the confocal switching member 31 is photoelectrically detected by a photomultiplier 33, thereby producing analog data.

The analog data produced by the photomultiplier 33 are converted by an A/D converter 34 into digital data.

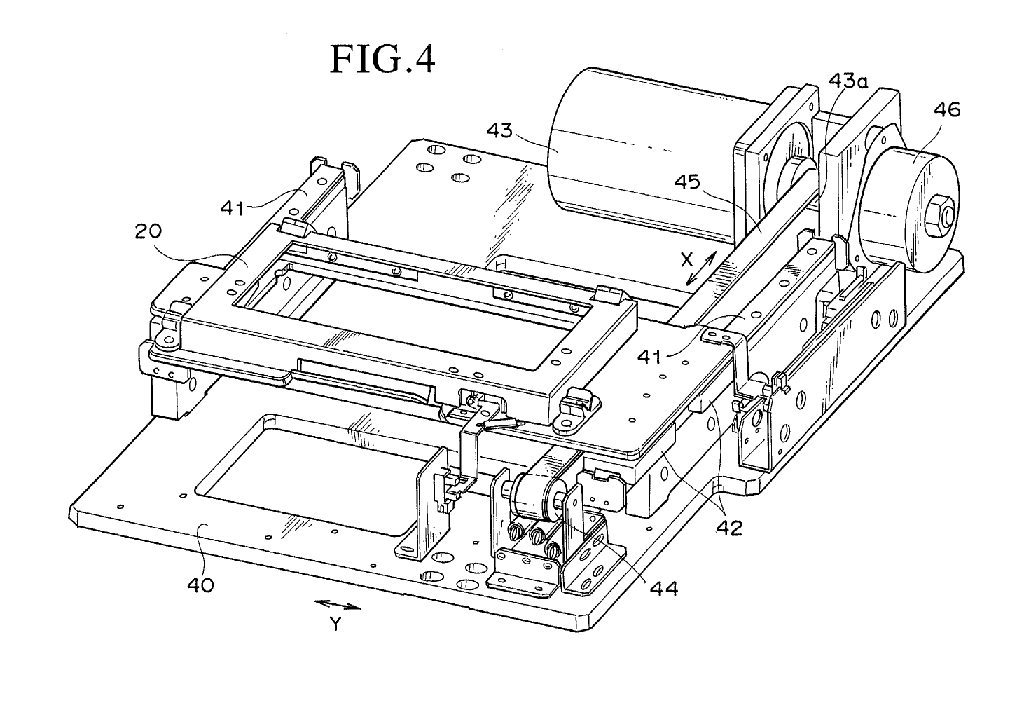

FIG. 4 is a schematic perspective view showing the details of a main scanning mechanism that is part of a scanning mechanism of a sample stage 20.

As shown in FIG. 4, a pair of guide rails 41, 41 are fixed on the movable base plate 40 movable in a sub-scanning direction indicated by an arrow Y in FIG. 4 by a sub-scanning motor (not shown) and the sample stage 20 is fixed to three side members 42, 42 (only two shown in FIG. 4.) slidably mounted on the pair of guide rails 41, 41.

As shown in FIG. 4, a main scanning motor 43 is fixed on the movable base plate 40. A timing belt 45 wound around a pulley 44 is wound around the output shaft 43a of the main scanning motor 43 and a rotary encoder 46 is secured to the output shaft 43a of the main scanning motor 43.

Therefore, the sample stage 20 can be reciprocated along the pair of guide rails 41, 41 in the main scanning direction indicated by an arrow X in FIG. 4 by driving the main scanning motor 43 and the sample stage 20 can be two-dimensionally moved by further moving the movable base plate 40 in the sub-scanning direction by the sub-scanning motor (not shown), thereby enabling the whole surface of the sample 22 set on the sample stage 20 to be scanned with the laser beam 4.

The position of the sample stage 20 can be monitored by the rotary encoder 46.

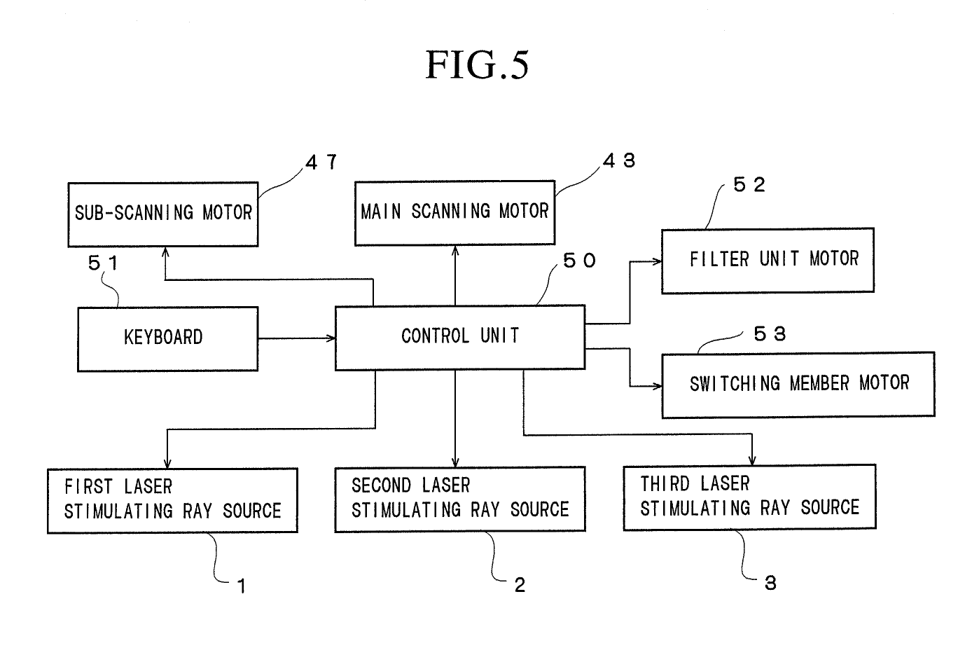

FIG. 5 is a block diagram of a control system, an input system and a drive system of the image reading apparatus shown in FIG. 1 and incorporated in the image analyzing system which is a preferred embodiment of the present invention.

As shown in FIG. 5, the control system of the image reading apparatus includes a control unit 50 for controlling the overall operation of the image reading apparatus and the input system of the image reading apparatus includes a keyboard 51 operated by the operator and through which various instruction signal can be input.

As shown in FIG. 5, the drive system of the image reading apparatus includes a filter unit motor 52 for moving the filter unit 27 provided with four filters 28a, 28b, 28c, 28d, a switching member motor 53 for moving the confocal switching member 31, the main scanning motor 43 for reciprocating the sample stage 20 in the main scanning direction and a sub-scanning motor 47 for intermittently moving the sample stage 20 in the sub-scanning direction.

The control unit 50 is constituted so as to selectively output a drive signal to the first laser stimulating ray source 1, the second laser stimulating ray source 2 or the third laser stimulating ray source 3 and also output drive signals to the filter unit motor 52, the switching member motor 53, the main scanning motor 43 and the sub-scanning motor 47.

The thus constituted image reading apparatus incorporated in the image analyzing system according to this embodiment reads an image of a plurality of spots 24 formed in the DNA micro-array 22 and produces template data prior to reading a fluorescent image of a fluorescent dye, a labeling substance, contained in the plurality of spots 24 formed in the DNA micro-array 22.

When the DNA micro-array 22 is set on the glass plate 21 of the sample stage 20, an instruction signal requesting reading of the DNA micro-array 22 is input through the keyboard 51.

The instruction signal requesting reading of the DNA micro-array 22 is input to the control unit 50 and when the control unit 50 receives the instruction signal requesting reading of the DNA micro-array 22, it outputs a drive signal to the switching member motor 53, thereby causing it to move the confocal switching member 31 so that the pinhole 32a having the smallest diameter is located in the optical path.

In this embodiment, a fluorescent dye, Fluor-X, effectively stimulable with a laser beam having a wavelength of 473 nm is mixed with a specimen solution containing a specific binding substance and all spots are labeled with Fluor-X. Therefore, when the template data are to be produced, the operator first inputs a template producing signal through the keyboard 51 together with an instruction signal specifying that the fluorescent dye is Fluor-X or an instruction signal specifying a laser stimulating ray source to be used.

The template producing signal and the instruction signal are input to the control unit 50 and when the control unit 50 receives the template producing signal and the instruction signal, it selects the third laser stimulating ray source 3 based on the instruction signal in accordance with a table stored in a memory (not shown). The control unit 50 then selects the filter 28c and outputs a drive signal to the filter unit motor 52, thereby moving the filter unit 27 so that the filter 28c having a property to cut off light having a wavelength of 473 nm but transmit light having a wavelength longer than 473 nm is located in the optical path.

The control unit 50 then outputs a drive signal to the third laser stimulating ray source 3 to activate the third laser stimulating ray source 3, thereby causing it to emit a laser beam 4 having a wavelength of 473 nm.

The laser beam 4 emitted from the third laser stimulating ray source 3 passes through a collimator lens 10, thereby being made a parallel beam, and is reflected by the second dichroic mirror 8, thereby changing its direction by 90 degrees to enter the optical head 15.

The laser beam 4 entering the optical unit 15 is reflected by the mirror 16, passes through the hole 17 formed in the perforated mirror 18 and through the lens 19 to impinge on the DNA micro-array 22 set on the sample stage 20.

As a result, Fluor-X contained in the plurality of spots 24 formed in the DNA micro-array 22 is stimulated by the laser beam 4, thereby releasing fluorescence emission.

The fluorescence emission 25 released from Fluor-X passes through the lens 19, thereby being made a parallel beam, and is reflected by the perforated mirror 18, thereby entering the filter unit 27.

Since the filter unit 27 has been moved so that the filter 28c is located in the optical path, the fluorescent light enters the filter 28c, thereby cutting light having a wavelength of 473 nm and transmitting only light having a wavelength longer than 473 nm.

The fluorescent light transmitted through the filter 28c is reflected by the mirror 29 and focused by the lens 30.

Since the confocal switching member 31 has been moved prior to the irradiation with the laser beam 4 so that the pinhole 32a having the smallest diameter is located in the optical path, the fluorescence emission 25 is focused onto the pinhole 32a and is photoelectrically detected by the photomultiplier 33 thereby producing analog data.

Fluorescence emission 25 released from a fluorescent dye on the surface of the slide glass plate 23 is led to the photomultiplier 33 using a confocal optical system to be photoelectrically detected in this manner and, therefore, noise in the image data can be minimized.

As described above, since the sample stage 20 is moved at a high speed by the main scanning motor 43 in the main scanning direction indicated by an arrow X in FIG. 4 and is moved by the sub-scanning motor 47 in the sub-scanning direction indicated by an arrow Y in FIG. 4, the whole surface of the DNA micro-array 22 is scanned with the laser beam 4.

Thus, an image of the plurality of spots 24 formed on the DNA micro-array 22 is read by photoelectrically detecting fluorescence emission 25 released from Fluor-X contained in the plurality of spots 24 and analog template data can be produced.

The analog template data produced by photoelectrically detecting fluorescence emission by the photomultiplier 33 are converted to a digital signal by the A/D converter 34 with a scale factor suitable for the signal fluctuation width, whereby template data are produced and input to a line buffer 35.

The line buffer 35 temporarily stores image data corresponding to one scanning line. When the template data corresponding to one scanning line have been stored in the line buffer 35 in the above described manner, the line buffer 35 outputs the template data to a transmitting buffer 36 whose capacity is greater than that of the line buffer 35 and when the transmitting buffer 36 has stored a predetermined amount of the template data, it outputs the template data to an image analyzing apparatus 60.

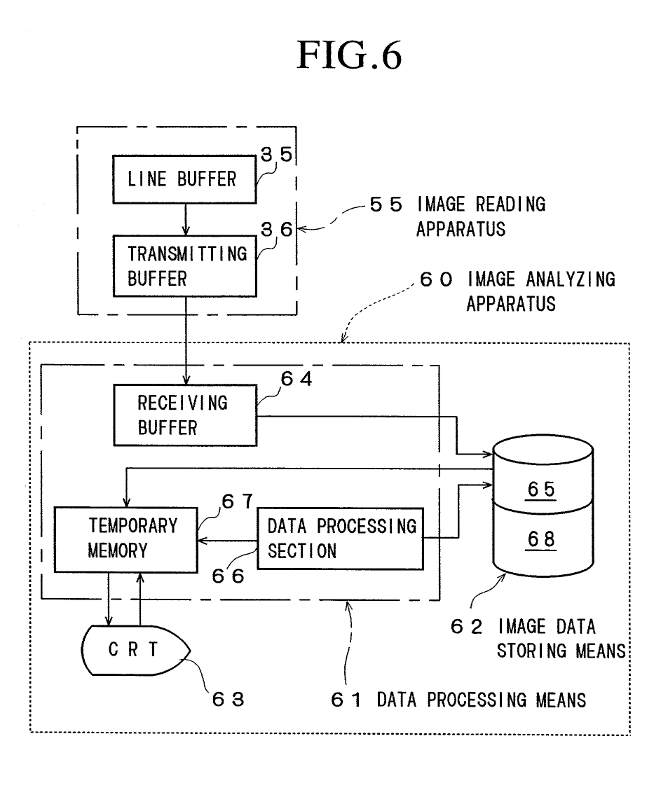

FIG. 6 is a block diagram of the image analyzing apparatus 60 incorporated in the image analyzing system which is a preferred embodiment of the present invention.

As shown in FIG. 6, the image analyzing apparatus 60 includes data processing means 61 for receiving image data such as template data read by the image reading apparatus 55 and converted to a digital signal, processing them so as to reproduce a visible image which has desirable density, tone, contrast and the like, and has excellent observation and analysis property and analyzing image data, image data storing means 62 for storing image data which were subjected to data processing by the data processing means 61, and a CRT 63 for reproducing an image based on the image data.

The template data temporarily stored in the transmitting buffer 36 of the image reading apparatus 55 are input to a receiving buffer 64 in the data processing means 61 of the image analyzing apparatus 60 and temporarily stored therein. When a predetermined amount of the template data have been stored in the receiving buffer 64, the stored template data are output to an image data temporary storing section 65 in the image data storing means 62 and stored therein.

In this manner, the template data fed from the transmitting buffer 36 of the image reading apparatus 55 to the receiving buffer 64 of the data processing means 61 and temporarily stored therein are fed from the receiving buffer 64 to the image data temporary storing section 65 in the image data storing means 62 and stored therein.

When the template data obtained by scanning the whole surface of the DNA micro-array 22 with the laser beam 4 have been stored in the image data temporary storing section 65 in the image data storing means 62, the data processing section 66 in the data processing means 61 reads the template data from the image data temporary storing section 65 and stores them in a temporary memory 67 in the data processing means 61. After the template data have been subjected to necessary data processing in the data processing section 66, the data processing section 66 stores only the processed template data in an image data storing section 68 in the image data storing means 62. The data processing section 66 then erases the template data stored in the image data temporary storing section 65.

The image data stored in the image data storing section 68 in the image data storing means 62 can be read by the data processing section 66 and displayed on the screen of the CRT 63 so that an operator can view and analyze the image.

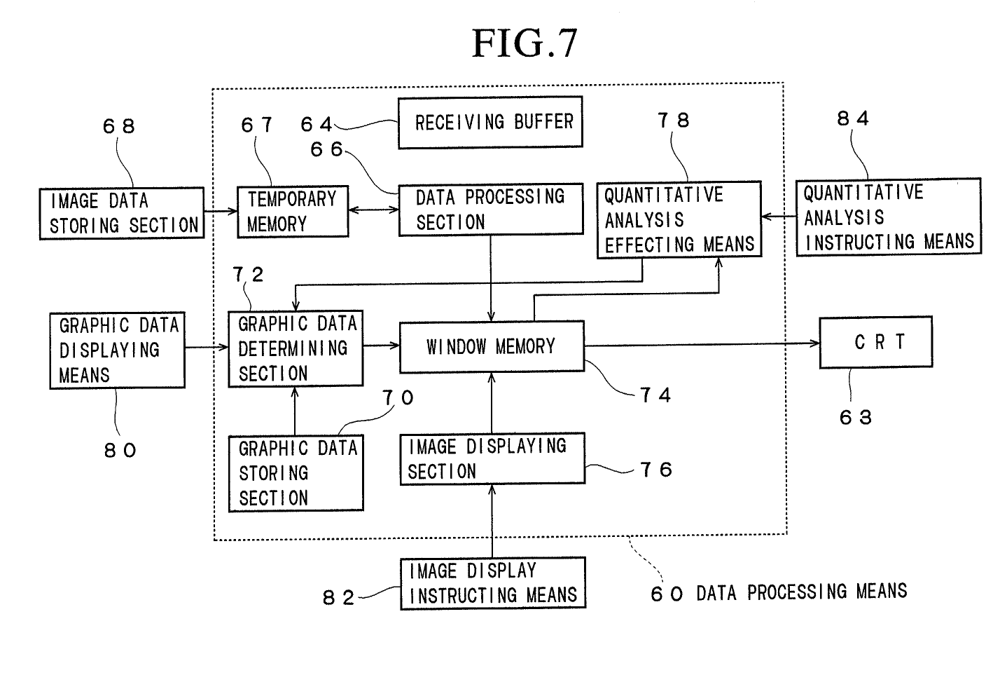

FIG. 7 is a block diagram of a data processing means of the image analyzing apparatus 60 incorporated in the image analyzing system which is a preferred embodiment of the present invention.

As shown in FIG. 7, the data processing means 61 includes the receiving buffer 64 for receiving image data from the transmitting buffer 36 in the image reading apparatus 55, the data processing section 66 for effecting data processing and the temporary memory 67 for temporarily storing image data. The temporary memory 67 is adapted to two-dimensionally map image data and temporarily store the mapped data.

The data processing means 61 further includes a graphic data storing section 70 for storing various graphic data to be displayed on the CRT 63, a graphic data determining section 72 for selecting predetermined graphic data from among the graphic data stored in the graphic data storing section 70 and specifying the position and the size of the graphic data in order to superpose them on the image data two-dimensionally mapped and temporarily stored in the temporary memory 67, a window memory 74 for two-dimensionally mapping and temporarily storing the image data and the graphic data obtained by synthesizing image data temporarily stored in the temporary memory 67 and the graphic data which were selected by the graphic data determining section 72 and whose position and size are determined by the graphic data determining section 72, an image displaying section 76 for reproducing an image on the screen of the CRT 63 based on the image data and the graphic data two-dimensionally mapped and temporarily stored in the window memory 84, and a quantitative analysis effecting means 78 for defining regions of interest to be quantified in image data and effecting quantitative analysis.

A graphic data displaying signal is sent from graphic data displaying means 80 to the graphic data determining section 72 and an image display instructing signal is input to the image displaying section 76 from image display instructing means 82. Further, a quantitative analysis instructing signal is input to the quantitative analysis effecting means 78 from quantitative analysis instructing means 84.

In this embodiment, the graphic data displaying means 80, the image display instructing means 82 and the quantitative analysis instructing means 84 are constituted so as to be operated by the keyboard 51 or a mouse (not shown).

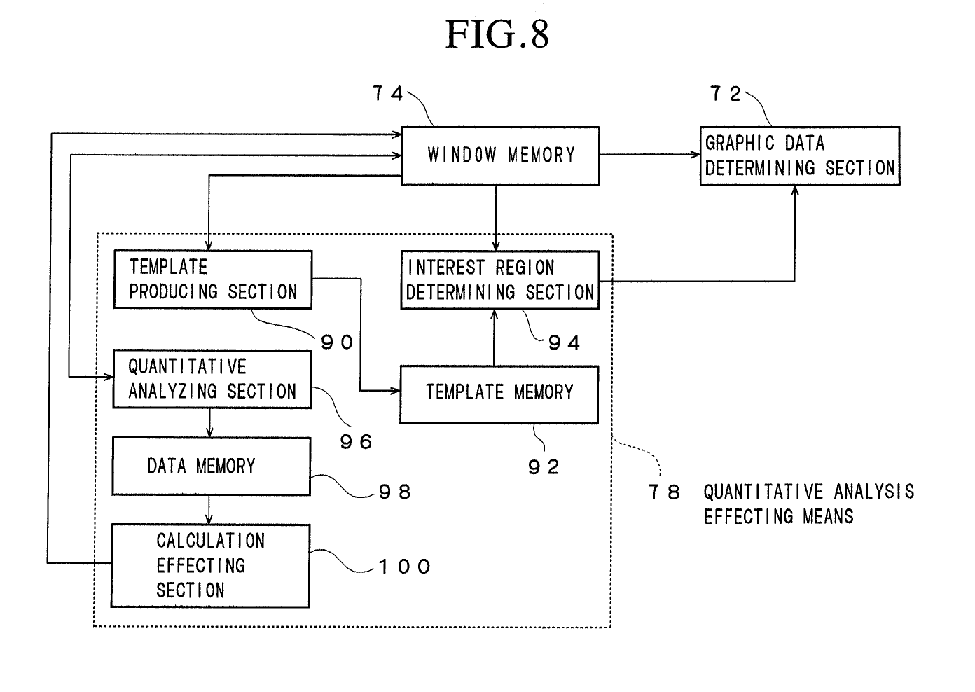

FIG. 8 is a block diagram of the quantitative analysis effecting means 78 provided in the data processing means 61 of the image analyzing apparatus 60 incorporated in the image analyzing system which is a preferred embodiment of the present invention.

As shown in FIG. 8, the quantitative analysis effecting means 78 includes a template producing section 90 for reading template data two-dimensionally mapped and temporarily stored in the window memory 74 and producing a template based on the template data, a template memory 67 for two-dimensionally mapping and storing the template produced by the template producing section 90, an interest region determining section 94 for reading image data two-dimensionally mapped and temporarily stored in the window memory 74, effecting template fitting between the image data and the template stored in the template memory 92, thereby defining data regions for defining regions of interest in the image data, outputting an interest region definition signal to the graphic data determining section 72, synthesizing graphic data which are selected by the graphic data determining section 72 and whose position and size are determined by the graphic data determining section 72 and image data temporarily stored in the temporary memory 67, thereby defining regions of interest in the image data and two-dimensionally mapping and temporarily storing them in the window memory 74, and a quantitative analyzing section 96 for reading the image data two-dimensionally mapped and temporarily stored in the window memory 74 and effecting quantitative analysis, a data memory 98 for storing quantitative analysis data, and a calculation effecting section 100 for effecting various calculation.

The thus constituted image analyzing apparatus displays a template image on the screen of the CRT 63 by two-dimensionally mapping and temporarily storing template data stored in the image data storing section 68 in the temporary memory 67, then two-dimensionally mapping and storing them in the window memory 74 without synthesizing them with graphic data and operating the image display instructing means 82.

When a template producing signal is input, the control unit 50 outputs a production signal to the template producing section 90, thereby causing it to read two-dimensionally mapped and stored template data in the window memory 74 and to produce a template and two-dimensionally maps and stores the template in the template memory 92.

When the template has been produced and two-dimensionally mapped and stored in the template memory 92 in this manner, fluorescent image data of a labeling substance Cy3 or Cy5 contained in the plurality of spots 24 formed in the DNA micro-array 22 are produced.

In the case where fluorescent image data of a labeling substance Cy3 contained in the plurality of spots 24 formed in the DNA micro-array 22 are to be produced, a fluorescent image data producing signal is input through the keyboard 51 by the operator together with an instruction signal specifying that the fluorescent dye is Cy3 or an instruction signal specifying the laser stimulating ray source to be used.

The fluorescent image data producing signal and the instruction signal are input to the control unit 50 and when the control unit 50 receives the fluorescent image data producing signal and the instruction signal, it selects the second laser stimulating ray source 2 based on the instruction signal in accordance with a table stored in a memory (not shown). The control unit 50 then selects the filter 28b and outputs a drive signal to the filter unit motor 52, thereby moving the filter unit 27 so that the filter 28b having a property to cut off light having a wavelength of 532 nm but transmit light having a wavelength longer than 532 nm is located in the optical path.

The control unit 50 then outputs a drive signal to the second laser stimulating ray source 2 to activate the second laser stimulating ray source 2, thereby causing it to emit a laser beam 4 having a wavelength of 532 nm.

The laser beam 4 emitted from the second laser stimulating ray source 2 passes through a collimator lens 9, thereby being made a parallel beam, and advances to the first dichroic mirror 7 to be reflected thereby.

The laser beam 4 reflected by the first dichroic mirror 7 passes through the second dichroic mirror 8 and enters the optical head 15.

The laser beam 4 entering the optical unit 15 is reflected by the mirror 16, passes through the hole 17 formed in the perforated mirror 18 and through the lens 19 to impinge on the DNA micro-array 22 set on the sample stage 20.

As a result, Cy3 contained in the plurality of spots 24 formed in the DNA micro-array 22 is stimulated by the laser beam 4, thereby releasing fluorescence emission.

The fluorescence emission 25 released from Cy3 passes through the lens 19, thereby being made a parallel beam, and is reflected by the perforated mirror 18, thereby entering the filter unit 27.

Since the filter unit 27 has been moved so that the filter 28b is located in the optical path, the fluorescent light enters the filter 28b, thereby cutting light having a wavelength of 532 nm and transmitting only light having a wavelength longer than 532 nm.

Therefore, a light component having a wavelength of 532 nm equal to that of the stimulating ray is cut off and only light components having a wavelength of fluorescence emission released from Cy3 transmit through the filter 28b.

The fluorescent light transmitted through the filter 28b is reflected by the mirror 29 and focused by the lens 30.

Since the confocal switching member 31 has been moved prior to the irradiation with the laser beam 4 so that the pinhole 32a having the smallest diameter is located in the optical path, the fluorescence emission 25 is focused onto the pinhole 32a and is photoelectrically detected by the photomultiplier 33, thereby producing analog data.

Fluorescence emission 25 released from a fluorescent dye on the surface of the slide glass plate 23 is led to the photomultiplier 33 using a confocal optical system to be photoelectrically detected in this manner and, therefore, noise in the image data can be minimized.

As described above, since the sample stage 20 is moved at a high speed by the main scanning motor 43 in the main scanning direction indicated by an arrow X in FIG. 4 and is moved by the sub-scanning motor 47 in the sub-scanning direction indicated by an arrow Y in FIG. 4, the whole surface of the DNA micro-array 22 is scanned with the laser beam 4. Therefore, a fluorescent image of Cy3 selectively contained in the plurality of spots 24 formed on the DNA micro-array 22 is read by photoelectrically detecting fluorescence emission 25 released from Cy3 selectively contained in the plurality of spots 24 by the photomultiplier 33 and analog template data can be produced.

The analog template data produced by photoelectrically detecting fluorescence emission by the photomultiplier 33 are converted to a digital signal by the A/D converter 34 with a scale factor suitable for the signal fluctuation width, whereby template data are produced and input to the line buffer 35.

When the fluorescent image data corresponding to one scanning line have been stored in the line buffer 35, the line buffer 35 outputs the fluorescent image data to the transmitting buffer 36 whose capacity is greater than that of the line buffer 35 and when the transmitting buffer 36 has stored a predetermined amount of the fluorescent image data, it outputs the fluorescent image data to an image analyzing apparatus 60.

The image data temporarily stored in the transmitting buffer 36 of the image reading apparatus 55 are input to a receiving buffer 64 in the data processing means 61 of the image analyzing apparatus 60 and temporarily stored therein. When a predetermined amount of the image data have been stored in the receiving buffer 64, the stored image data are output to an image data temporary storing section 65 in the image data storing means 62 and stored therein.

In this manner, the image data fed from the transmitting buffer 36 of the image reading apparatus 55 to the receiving buffer 64 of the data processing means 61 and temporarily stored therein are fed from the receiving buffer 64 to the image data temporary storing section 65 in the image data storing means 62 and stored therein.

When the image data obtained by scanning the whole surface of the DNA micro-array 22 with the laser beam 4 have been stored in the image data temporary storing section 65 in the image data storing means 62, the data processing section 66 in the data processing means 61 reads the image data from the image data temporary storing section 65 and stores them in a temporary memory 67 in the data processing means 61. After the image data have been subjected to necessary data processing in the data processing section 66, the data processing section 66 stores only the processed image data in an image data storing section 68 in the image data storing means 62. The data processing section 66 then erases the image data stored in the image data temporary storing section 65.

The image data stored in the image data storing section 68 are two-dimensionally mapped and stored in the temporary memory 67 and are then two-dimensionally mapped and stored in the window memory 74 without being synthesized with graphic data. When the image display instructing means 82 is operated, a fluorescent image is displayed on the screen of the CRT 63.

When the quantitative analysis effecting means 84 is operated by the operator, a quantitative analysis instructing signal is input to the quantitative analysis effecting means 78 from the quantitative analysis instructing means 84.

When the quantitative analysis instructing means 84 receives the quantitative analysis instructing signal, the interest region determining section 94 of the quantitative analysis instructing means 84 reads the image data two-dimensionally mapped and stored in the window memory 74 and the template produced by the template producing section 90 and two-dimensionally mapped and stored in the template memory 92 and effects template fitting therebetween, thereby defining data regions on which regions of interest are determined in the image data and outputs an interest region determining signal to the graphic data determining section 72.

When the graphic data determining section 72 receives the interest region determining signal from the interest region determining section 94, it selects predetermined graphic data from among graphic data stored in the graphic data storing section 70, determines the position and size of a figure in order to superimpose the selected graphic data on the image data two-dimensionally mapped and temporarily stored in the temporary memory 67, synthesizes the image data temporarily stored in the temporary memory 67 and the graphic data which have been selected from among graphic data stored in the graphic data storing section 70 and whose position and size have been determined, and two-dimensionally maps and temporarily stores the thus synthesized image data and graphic data in the window memory 74.

Thus, a region of interest to be quantitatively analyzed is defined by the figure selected by the graphic data determining section 72 in the image data two-dimensionally mapped and temporarily stored in the window memory 74.

When the image display instructing means 82 is operated, an image display instructing signal is output to the image display section 76 from the image display instructing means 82 and a fluorescent image in which a region of interest is defined is displayed on the screen of the CRT 63.

The quantitative analyzing section 96 of the quantitative analysis effecting means 78 reads the image data in which a region of interest to be quantitatively analyzed is defined and which are two-dimensionally mapped and temporarily stored in the window memory 74, effects quantitative analysis, stores the result of the quantitative analysis in the data memory 98 and outputs it to the window memory 74.

When the image display instructing means 82 is operated, an image display instructing signal is output to the image display section 76 from the image display instructing means 82, whereby the result of the quantitative analysis output to the window memory 74 is displayed on the screen of the CRT 63.

When the fluorescent image data of Cy3 have been produced, the region of interest has been defined and the result of the quantitative analysis has been displayed on the screen of the CRT 63, fluorescent image data of the labeling substance Cy5, contained in the plurality of spots 24 formed in the DNA micro-array 22 are produced.

In the case where fluorescent image data of the labeling substance Cy5 contained in the plurality of spots 24 formed in the DNA micro-array 22 are to be produced, a fluorescent image data producing signal is input through the keyboard 51 by the operator together with an instruction signal specifying that the fluorescent dye is Cy5 or an instruction signal specifying a laser stimulating ray source to be used.

The fluorescent image data producing signal and the instruction signal are input to the control unit 50 and when the control unit 50 receives the fluorescent image data producing signal and the instruction signal, it selects the first laser stimulating ray source 1 based on the instruction signal in accordance with a table stored in a memory (not shown). The control unit 50 then selects the filter 28a and outputs a drive signal to the filter unit motor 52, thereby moving the filter unit 27 so that the filter 28a having a property to cut off light having a wavelength of 640 nm but transmit light having a wavelength longer than 640 nm is located in the optical path.

The control unit 50 then outputs a drive signal to the first laser stimulating ray source 1 to activate the first laser stimulating ray source 1, thereby causing it to emit a laser beam 4 having a wavelength of 640 nm.

The laser beam 4 emitted from the first laser stimulating ray source 1 passes through a collimator lens 5, thereby being made a parallel beam, and advances to the mirror 5 to be reflected thereby.

The laser beam 4 reflected by the mirror 5 passes through the first dichroic mirror 8 and the second dichroic mirror 9 and enters the optical head 15.

The laser beam 4 entering the optical unit 15 is reflected by the mirror 16, passes through the hole 17 formed in the perforated mirror 18 and through the lens 19 to impinge on the DNA micro-array 22 set on the sample stage 20.

As a result, Cy5 contained in the plurality of spots 24 formed in the DNA micro-array 22 is stimulated by the laser beam 4, thereby releasing fluorescence emission.

The fluorescence emission 25 released from Cy5 passes through the lens 19, thereby being made a parallel beam, and is reflected by the perforated mirror 18, thereby entering the filter unit 27.

Since the filter unit 27 has been moved so that the filter 28a is located in the optical path, the fluorescent light enters the filter 28a, thereby cutting light having a wavelength of 640 nm and transmitting only light having a wavelength longer than 640 nm.

Therefore, a light component having a wavelength of 640 nm equal to that of the stimulating ray is cut off and only light components having a wavelength of fluorescence emission released from Cy5 transmit through the filter 28a.

The fluorescent light transmitted through the filter 28a is reflected by the mirror 29 and focused by the lens 30.

Since the confocal switching member 31 has been moved prior to the irradiation with the laser beam 4 so that the pinhole 32a having the smallest diameter is located in the optical path, the fluorescence emission 25 is focused onto the pinhole 32a and is photoelectrically detected by the photomultiplier 33 thereby producing analog data.

Fluorescence emission 25 released from a fluorescent dye on the surface of the slide glass plate 23 is led to the photomultiplier 33 using a confocal optical system to be photoelectrically detected in this manner and, therefore, noise in the image data can be minimized.

As described above, since the sample stage 20 is moved at a high speed by the main scanning motor 43 in the main scanning direction indicated by an arrow X in FIG. 4 and is moved by the sub-scanning motor 47 in the sub-scanning direction indicated by an arrow Y in FIG. 4, the whole surface of the DNA micro-array 22 is scanned with the laser beam 4. Therefore, a fluorescent image of Cy5 selectively contained in the plurality of spots 24 formed on the DNA micro-array 22 is read by photoelectrically detecting fluorescence emission 25 released from Cy5 selectively contained in the plurality of spots 24 by the photomultiplier 33 and analog template data can be produced.

The analog template data produced by photoelectrically detecting fluorescence emission by the photomultiplier 33 are converted to a digital signal by the A/D converter 34 with a scale factor suitable for the signal fluctuation width, whereby template data are produced and input to the line buffer 35.

When the fluorescent image data corresponding to one scanning line have been stored in the line buffer 35, the line buffer 35 outputs the fluorescent image data to the transmitting buffer 36 whose capacity is greater than that of the line buffer 35 and when the transmitting buffer 36 has stored a predetermined amount of the fluorescent image data, it outputs the fluorescent image data to an image analyzing apparatus 60.

The image data temporarily stored in the transmitting buffer 36 of the image reading apparatus 55 are input to a receiving buffer 64 in the data processing means 61 of the image analyzing apparatus 60 and temporarily stored therein. When a predetermined amount of the image data have been stored in the receiving buffer 64, the stored image data are output to an image data temporary storing section 65 in the image data storing means 62 and stored therein.

In this manner, the image data fed from the transmitting buffer 36 of the image reading apparatus 55 to the receiving buffer 64 of the data processing means 61 and temporarily stored therein are fed from the receiving buffer 64 to the image data temporary storing section 65 in the image data storing means 62 and stored therein.

When the image data obtained by scanning the whole surface of the DNA micro-array 22 with the laser beam 4 have been stored in the image data temporary storing section 65 in the image data storing means 62, the data processing section 66 in the data processing means 61 reads the image data from the image data temporary storing section 65 and stores them in a temporary memory 67 in the data processing means 61. After the image data have been subjected to necessary data processing in the data processing section 66, the data processing section 66 stores only the processed image data in an image data storing section 68 in the image data storing means 62. The data processing section 66 then erases the image data stored in the image data temporary storing section 65.

The image data stored in the image data storing section 68 are two-dimensionally mapped and stored in the temporary memory 67 and are then two-dimensionally mapped and stored in the window memory 74 without being synthesized with graphic data. When the image display instructing means 82 is operated, a fluorescent image is displayed on the screen of the CRT 63.

When the quantitative analysis effecting means 84 is operated by the operator, a quantitative analysis instructing signal is input to the quantitative analysis effecting means 78 from the quantitative analysis instructing means 84.

When the quantitative analysis instructing means 84 receives the quantitative analysis instructing signal, the interest region determining section 94 of the quantitative analysis instructing means 84 reads the image data two-dimensionally mapped and stored in the window memory 74 and the template produced by the template producing section 90 and two-dimensionally mapped and stored in the template memory 92 and effects template fitting therebetween, thereby defining data regions on which regions of interest are determined in the image data and outputs an interest region determining signal to the graphic data determining section 72.

When the graphic data determining section 72 receives the interest region determining signal from the interest region determining section 94, it selects predetermined graphic data from among graphic data stored in the graphic data storing section 70, determines the position and size of a figure in order to superimpose the selected graphic data on the image data two-dimensionally mapped and temporarily stored in the temporary memory 67, synthesizes the image data temporarily stored in the temporary memory 67 and the graphic data which have been selected from among graphic data stored in the graphic data storing section 70 and whose position and size have been determined, and two-dimensionally maps and temporarily stores the thus synthesized image data and graphic data in the window memory 74.

Thus, a region of interest to be quantitatively analyzed is defined by the figure selected by the graphic data determining section 72 in the image data two-dimensionally mapped and temporarily stored in the window memory 74.

When the image display instructing means 82 is operated, an image display instructing signal is output to the image display section 76 from the image display instructing means 82 and a fluorescent image in which a region of interest is defined is displayed on the screen of the CRT 63.

The quantitative analyzing section 96 of the quantitative analysis effecting means 78 reads the image data in which a region of interest to be quantitatively analyzed is defined and which are two-dimensionally mapped and temporarily stored in the window memory 74, effects quantitative analysis, stores the result of the quantitative analysis in the data memory 98 and outputs it to the window memory 74.

When the image display instructing means 82 is operated, an image display instructing signal is output to the image display section 76 from the image display instructing means 82, whereby the result of the quantitative analysis output to the window memory 74 is displayed on the screen of the CRT 63.

When the fluorescent image data of Cy5 have been produced, the region of interest has been defined and the result of the quantitative analysis has been displayed on the screen of the CRT 63 in this manner, the quantitative analysis is completed.

In the case where it is further necessary to calculate a ratio of the intensity of fluorescence emission in the fluorescent image of Cy3 and the intensity of fluorescence emission in the fluorescent image of Cy5 or the like, the operator specifies the content of calculation and inputs a calculation instructing signal to request effecting of the calculation through the keyboard 51.

When the control unit 50 receives the calculation instructing signal, it transmits the calculation instructing signal to the quantitative analysis effecting means 78.

When the calculation effecting section 100 of the quantitative analysis effecting means 78 receives the calculation instructing signal, it reads the result of quantitative analysis of the fluorescent image data of Cy3 and the result of quantitative analysis of the fluorescent image data of Cy5 stored in the data memory 98 and calculates a ratio of the intensities of fluorescence emission in the respective fluorescent images to output it to the window memory 74.

When the image display instructing means 82 is operated, an image display instructing signal is output to the image display section 76 from the image display instructing means 82, whereby the result of the calculation out put to the window memory 74 is displayed on the screen of the CRT 63.

The results of calculation effected by the calculation effecting section 100 can be stored in the data memory 98 or the like as occasion demands.

In the case where a radiation image such as an autoradiographic image recorded in a stimulable phosphor layer of the stimulable phosphor sheet is to be read, an image is read and radiation image data are produced by setting the stimulable phosphor sheet on the sample stage 20 instead of the DNA micro-array 22 and selecting the first laser stimulating ray source 1 and the filter 28d.

In this embodiment, specimen solutions containing two or more kinds of cDNA probes mixed with a fluorescent dye, Fluor-X (registered trademark), are spot-like dropped onto the slide glass plate 23 to form a plurality of spots 24. A first probe DNA labeled with Cy3 and a second probe DNA labeled with Cy5 are mixed and the thus mixed solution is gently loaded onto the surface of the slide glass plate 23 on which cDNAs, specific binding substances, are spotted, and then hybridization is performed, thereby producing the DNA micro-array 22.

The first laser stimulating ray source 1 is activated and the thus produced DNA micro-array 22 is scanned with a laser beam 4 having a wavelength of 473 nm capable of efficiently stimulating Fluor-X, thereby stimulating Fluor-X contained in all of the plurality of spots. Fluorescence emission released from Fluor-X upon being stimulated is photoelectrically detected to produce template data and a template is produced based on the template data and stored in the data memory 98. The second laser stimulating ray source 2 is then activated and the DNA micro-array 22 is scanned with a laser beam 4 having a wavelength of 532 nm capable of efficiently stimulating Cy3, which is a first labeling substance, thereby stimulating Cy3 selectively contained in the plurality of spots.

Fluorescence emission released from Cy3 upon being stimulated is photoelectrically detected to produce fluorescent image data of Cy3. Template fitting is effected by the interest region determining means 94 between the image data and the template including images of all spots 24, thereby defining a region of interest to be quantitatively analyzed in the fluorescent image data of Cy3 and quantitative analysis is effected.

In this embodiment, the third laser stimulating ray source 3 is further activated and the DNA micro-array 22 is scanned with a laser beam 4 having a wavelength of 640 nm capable of efficiently stimulating Cy5 selectively contained in the plurality of spots. Fluorescence emission released from Cy5 upon being stimulated is photoelectrically detected to produce fluorescent image data of Cy5. Template fitting is effected by the interest region determining means 94 between the image data and the template including images of all spots 24, thereby defining a region of interest to be quantitatively analyzed in the fluorescent image data of Cy5 and quantitative analysis is effected.

Therefore, according to the above described embodiment, since regions of interest are defined in the fluorescent image data of Cy3 and the fluorescent image data of Cy5 using the template including images of all spots 24 formed in the DNA micro-array 22, even if a specific binding substance cannot be spotted onto a desired position on the surface of a substrate such as a slide glass plate, a membrane filter or the like due to spotting error of the spotter, it is still possible to determine the positions of all spots based on the template data and, therefore, it is possible to produce a template for defining regions of interest to be quantified in a desired manner and accurately effect quantitative analysis based on the template.

The present invention has thus been shown and described with reference to specific embodiments. However, it should be noted that the present invention is in no way limited to the details of the described arrangements but changes and modifications may be made without departing from the scope of the appended claims.

For example, in the above described embodiment, the explanation was made as to the reading of fluorescent images carried in the DNA micro-array 22 prepared by the steps of spot-like dropping specimen solutions containing two or more kinds of cDNA probes mixed with a fluorescent dye, Fluor-X, onto the slide glass plate 23 to form a plurality of spots 24, extracting a specimen of RNA from biological cells, extracting mRNA having poly A at 3′ terminal from the RNA, synthesizing cDNA in the presence of a labeling substance, Cy3, to prepare first target DNA labeled with Cy3, extracting a specimen of RNA from biological cells, extracting mRNA having poly A at 3′ terminal from the RNA, synthesizing cDNA in the presence of a labeling substance, Cy5, to prepare second target DNA labeled with Cy5, mixing the first target DNA and the second target DNA, gently loading the mixed solution onto the surface of the slide glass plate 23 on which two or more kinds of cDNAs, specific binding substances, are spotted, and performing hybridization. However, the present invention is in no way limited to the reading of a fluorescent image carried in a DNA micro-array prepared in such a manner but can be widely applied to the reading of fluorescent images carried in micro-arrays prepared by the steps of dropping on the surface of a slide glass plate 23 or a membrane filter specific binding substances, which can specifically bind with a substance derived from a living organism such as a hormone, tumor marker, enzyme, antibody, antigen, abzyme, other protein, a nuclear acid, cDNA, DNA, RNA or the like and whose sequence, base length, composition and the like are known, thereby forming a number of independent spots 24, and hybridizing the specific binding substances whose sequence, base length, composition and the like are known with a substance derived from a living organism such as a hormone, tumor marker, enzyme, antibody, antigen, abzyme, other protein, a nuclear acid, cDNA, DNA or mRNA, which is gathered from a living organism by extraction, isolation or the like or is further subjected to chemical processing, chemical modification or the like and which is labeled with a labeling substance such as a fluorescent dye.

Further, in the above described embodiment, although a fluorescent dye, Fluor-X, is mixed with specimen solutions containing two or more kinds of cDNA probes, the first target DNA is labeled with Cy3 and the second target DNA is labeled with Cy5, it is sufficient for a fluorescent dye mixed with specimen solutions containing two or more kinds of cDNA probes, a fluorescent dye labeling the first target DNA and a fluorescent dye labeling the second target DNA to have properties to be efficiently stimulable with laser beams 4 having different wavelengths from each other and it is not absolutely necessary to mix a fluorescent dye, Fluor-X, with specimen solutions containing two or more kinds of cDNA probes, to label the first target DNA with Cy3 or to label the second target DNA with Cy5. It is, for example, possible to mix a fluorescent dye effectively stimulable with a laser beam 4 having a wavelength of 640 nm with specimen solutions containing two or more kinds of cDNA probes, to label first target DNA with a fluorescent dye effectively stimulable with a laser beam 4 having a wavelength of 473 nm and to label second target DNA with a fluorescent dye effectively stimulable with a laser beam 4 having a wavelength of 532 nm.

Furthermore, in the above described embodiment, the template data including image data of all spots 24 is produced by spot-like dropping specimen solutions containing two or more kinds of cDNA probes and mixed with a fluorescent dye, Fluor-X, onto the slide glass plate 23 to form a plurality of spots 24, irradiating all spots 24 with a laser beam 4 to stimulate Fluor-X and photoelectrically detecting fluorescence emission released from Fluor-X. However, it is sufficient that template data including image data of all spots 24 formed in the DNA micro-array 22 can be produced and it is not absolutely necessary to produce the template data including image data of all spots 24 by spot-like dropping specimen solutions containing two or more kinds of cDNA probes and mixed with a fluorescent dye, Fluor-X, onto the slide glass plate 23 to form a plurality of spots 24, irradiating all spots 24 with a laser beam 4 to stimulate Fluor-X and photoelectrically detecting fluorescence emission released from Fluor-X.

Moreover, in the above described embodiment, regions of interest are defined while the effect of the spotting error of the spotter is minimized and quantitative analysis is effected by spot-like dropping specimen solutions containing two or more kinds of cDNA probes mixed with a fluorescent dye, Fluor-X, onto the slide glass plate 23 to form a plurality of spots 24, extracting a specimen of RNA from biological cells, extracting mRNA having poly A at 3′ terminal from the RNA, synthesizing cDNA in the presence of a labeling substance Cy3, to prepare first target DNA labeled with Cy3, extracting a specimen of RNA from biological cells, extracting mRNA having poly A at 3′ terminal from the RNA, synthesizing cDNA in the presence of a labeling substance, Cy5, to prepare second target DNA labeled with Cy5, mixing the first target DNA and the second target DNA, gently loading the mixed solution onto the surface of the slide glass plate 23 on which two or more kinds of cDNAs, specific binding substances, are spotted, performing hybridization to prepare the DNA micro-array 22, irradiating the DNA micro-array 22 with a laser beam having a wavelength of 473 nm to stimulate Fluor-X, photoelectrically detecting fluorescence emission released from Fluor-X, producing template data including image data of all spots 24, producing fluorescent image data of Cy3 labeling the first target DNA using a laser beam 4 having a wavelength of 532 nm, defining a region of interest to be quantified in the fluorescent image data of Cy3 based on the template data, performing quantitative analysis, producing fluorescent image data of Cy5 labeling the second target DNA using a laser beam 4 having a wavelength of 640 nm, defining a region of interest to be quantified in the fluorescent image data of Cy5 based on the template data, and performing quantitative analysis. However, it is possible to define regions of interest to be quantified while the effect of the spotting error of the spotter is minimized and effect quantitative analysis by producing fluorescent image data of Cy3 labeling the first target DNA using a laser beam 4 having a wavelength of 532 nm, fluorescent image data of Cy5 labeling the second target DNA using a laser beam 4 having a wavelength of 640 nm, then scanning the DNA micro-array 22 with a laser beam 4 having a wavelength of 473 nm to stimulate Fluor-X, photoelectrically detecting fluorescence emission released from Fluor-X, producing template data including image data of all spots 24, defining a region of interest to be quantified in the fluorescent image data of Cy3 based on the template data, performing quantitative analysis, defining a region of interest to be quantified in the fluorescent image data of Cy5 based on the template data, and performing quantitative analysis.

Further, in the above described embodiment, the template data including image data of all spots 24 are produced by spot-like dropping specimen solutions containing two or more kinds of cDNA probes mixed with a fluorescent dye, Fluor-X, onto the slide glass plate 23 to form a plurality of spots 24, irradiating all spots 24 with a laser beam 4 to stimulate Fluor-X and photoelectrically detecting fluorescence emission released from Fluor-X. However, template data including image data of all spots 24 may be produced by, instead of mixing Fluor-X with specimen solutions, using a polymer containing a fluorescent dye effectively stimulable with a laser beam 4 having a different wavelength from that of the laser beam 4 capable of effectively stimulating a fluorescent dye labeling a target as a polymer for causing the viscosity of a specimen solution to be increased in order to form spots 24 on the slide glass plate 23 with a high density, mixing a specific binding substance with the polymer, dropping the polymer onto the slide glass plate 23 to form a plurality of spots 24, scanning all spots 24 with a laser beam 4 capable of effectively stimulating the fluorescent dye contained in the polymer, and photoelectrically detecting fluorescence emission released from the fluorescent dye. In this case, it is possible to scan all spots 24 with a laser beam 4 capable of effectively stimulating the fluorescent dye contained in the polymer to stimulate the fluorescent dye, photoelectrically detect fluorescence emission released from the fluorescent dye, produce template data including image data of all spots 24, then produce fluorescent image data of Cy3 labeling the first target DNA using a laser beam 4 having a wavelength of 532 nm, produce fluorescent image data of Cy5 labeling the second target DNA using a laser beam 4 having a wavelength of 640 nm, define a region of interest to be quantified in the fluorescent image data of Cy3 based on the template data, perform quantitative analysis, define a region of interest to be quantified in the fluorescent image data of Cy5 based on the template data, and perform quantitative analysis, and it is also possible to produce fluorescent image data of Cy3 labeling the first target DNA using a laser beam 4 having a wavelength of 532 nm, produce fluorescent image data of Cy5 labeling the second target DNA using a 6 laser beam 4 having a wavelength of 640 nm, then scan all spots with a laser beam 4 capable of effectively stimulating the fluorescent dye contained in the polymer to stimulate the fluorescent dye, photoelectrically detect fluorescence emission released from the fluorescent dye, produce template data including image data of all spots 24, define a region of interest to be quantified in the fluorescent image data of Cy3 based on the template data, perform quantitative analysis, define a region of interest to be quantified in the fluorescent image data of Cy5 based on the template data, and perform quantitative analysis.

Furthermore, in the above described embodiment, the template data including image data of all spots 24 are produced by spot-like dropping specimen solutions containing two or more kinds of cDNA probes mixed with a fluorescent dye, Fluor-X, onto the slide glass plate 23 to form a plurality of spots 24, irradiating all spots 24 with a laser beam 4 to stimulate Fluor-X and photoelectrically detecting fluorescence emission released from Fluor-X. However, template data including image data of all spots 24 may be produced without mixing any fluorescent dye with specimen solutions by activating the first laser stimulating ray source 1, the second laser stimulating ray source 2 or the third laser stimulating lay source 3 after the filter unit 27 has been moved by the filter unit motor 52 and held out of the optical path of fluorescence emission 25, scanning the DNA micro-array 22 with a laser beam 4 and photoelectrically detecting light of the laser beam 4 scattered by the spots 24. In this case, it is possible to activate the first laser stimulating ray source 1, the second laser stimulating ray source 2 or the third laser stimulating lay source 3 after the filter unit 27 has been moved by the filter unit motor 52 and held out of the optical path of fluorescence emission 25, scan the DNA micro-array 22 with a laser beam 4, photoelectrically detect light of the laser beam 4 scattered by the spots 24, thereby producing template data including image data of all spots 24, then produce fluorescent image data of Cy3 labeling the first target DNA using a laser beam 4 having a wavelength of 532 nm, produce fluorescent image data of Cy5 labeling the second target DNA using a laser beam 4 having a wavelength of 640 nm, define a region of interest to be quantified in the fluorescent image data of Cy3 based on the template data, perform quantitative analysis, define a region of interest to be quantified in the fluorescent image data of Cy5 based on the template data, and perform quantitative analysis, and it is also possible to produce fluorescent image data of Cy3 labeling the first target DNA using a laser beam 4 having a wavelength of 532 nm, produce fluorescent image data of Cy5 labeling the second target DNA using a laser beam 4 having a wavelength of 640 nm, then activate the first laser stimulating ray source 1, the second laser stimulating ray source 2 or the third laser stimulating lay source 3 after the filter unit 27 has been moved by the filter unit motor 52 and held out of the optical path of fluorescence emission 25, scan the DNA micro-array 22 with a laser beam 4, photoelectrically detect light of the laser beam 4 scattered by the spots 24, thereby producing template data including image data of all spots 24, define a region of interest to be quantified in the fluorescent image data of Cy3 based on the template data, perform quantitative analysis, define a region of interest to be quantified in the fluorescent image data of Cy5 based on the template data, and perform quantitative analysis.

Moreover, in the above described embodiment, the template data including image data of all spots 24 are produced by spot-like dropping specimen solutions containing two or more kinds of cDNA probes mixed with a fluorescent dye, Fluor-X, onto the slide glass plate 23 to form a plurality of spots 24, extracting a specimen of RNA from biological cells, extracting mRNA having poly A at 3′ terminal from the RNA, synthesizing cDNA in the presence of a labeling substance, Cy3, to prepare first target DNA labeled with Cy3, extracting a specimen of RNA from biological cells, extracting mRNA having poly A at 3′ terminal from the RNA, synthesizing cDNA in the presence of a labeling substance, Cy5, to prepare second target DNA labeled with Cy5, mixing the first target DNA and the second target DNA, gently loading the mixed solution onto the surface of the slide glass plate 23 on which two or more kinds of cDNAs, specific binding substances, are spotted, performing hybridization to prepare the DNA micro-array 22, then irradiating the DNA micro-array 22 with a laser beam having a wavelength of 473 nm to stimulate Fluor-X, and photoelectrically detecting fluorescence emission released from Fluor-X. However, it is possible to spot-like drop specimen solutions containing two or more kinds of cDNA probes mixed with Fluor-X onto the slide glass plate 23 to form a plurality of spots 24, then scan the plurality of spots 24 with a laser beam 4 having a wavelength of 473 nm to stimulate Fluor-X, photoelectrically detect fluorescence emission released from Fluor-X, thereby producing template data including image data of all spots 24, then extract a specimen of RNA from biological cells, extract mRNA having poly A at 3′ terminal from the RNA, synthesize cDNA in the presence of a labeling substance Cy3 to prepare first target DNA labeled with Cy3, extract a specimen of RNA from biological cells, extract mRNA having poly A at 3′ terminal from the RNA, synthesize cDNA in the presence of a labeling substance Cy5 to prepare second target DNA labeled with Cy5, mix the first target DNA and the second target DNA, gently load the mixed solution onto the surface of the slide glass plate 23 on which two or more kinds of cDNAs, specific binding substances, are spotted, perform hybridization, and produce fluorescent image data of Cy3 labeling the first target DNA and fluorescent image data of Cy5 labeling the second target DNA.

Further, in the above described embodiment, the template data including image data of all spots 24 are produced by spot-like dropping specimen solutions containing two or more kinds of cDNA probes mixed with a fluorescent dye, Fluor-X, onto the slide glass plate 23 to form a plurality of spots 24, extracting a specimen of RNA from biological cells, extracting mRNA having poly A at 3′ terminal from the RNA, synthesizing cDNA in the presence of a labeling substance Cy3 to prepare first target DNA labeled with Cy3, extracting a specimen of RNA from biological cells, extracting mRNA having poly A at 3′ terminal from the RNA, synthesizing cDNA in the presence of a labeling substance, Cy5, to prepare second target DNA labeled with Cy5, mixing the first target DNA and the second target DNA, gently loading the mixed solution onto the surface of the slide glass plate 23 on which two or more kinds of cDNAs, specific binding substances, are spotted, performing hybridization to prepare the DNA micro-array 22, producing template data using a laser beam 4 having a wavelength of 473 nm, produce fluorescent image data of Cy3 labeling the first target DNA, and produce fluorescent image data of Cy5 labeling the second target DNA. However, it is possible to define regions of interest while the effect of the spotting error of the spotter is minimized and effect quantitative analysis by spot-like dropping a solution mixed with Fluor-X onto the surface of a slide glass plate 23 using a spotter to form a plurality of spots 24, scanning all spots 24 with a laser beam 4 having a wavelength of 473 nm to stimulate Fluor-X, photoelectrically detecting fluorescence emission released from Fluor-X, thereby producing template data, spot-like dropping specimen solutions containing two or more kinds of cDNA probes onto the surface of another slide glass plate 23 using the same spotter to form a plurality of spots 24, extracting a specimen of RNA from biological cells, extracting mRNA having poly A at 3′ terminal from the RNA, synthesizing cDNA in the presence of a labeling substance, Cy3, to prepare first target DNA labeled with Cy3, extracting a specimen of RNA from biological cells, extracting mRNA having poly A at 3′ terminal from the RNA, synthesizing cDNA in the presence of a labeling substance, Cy5, to prepare second target DNA labeled with Cy5, mixing the first target DNA and the second target DNA, gently loading the mixed solution onto the surface of the slide glass plate 23 on which two or more kinds of cDNAs, specific binding substances, are spotted, performing hybridization to prepare the DNA micro-array 22, producing fluorescent image data of Cy3 labeling the first target DNA using a laser beam 4 having a wavelength of 532 nm, defining a region of interest to be quantified in the fluorescent image data of Cy3 based on the template data, performing quantitative analysis, producing fluorescent image data of Cy5 labeling the second target DNA using a laser beam 4 having a wavelength of 640 nm, defining a region of interest to be quantified in the fluorescent image data of Cy5 based on the template data, and performing quantitative analysis.

Furthermore, in the above described embodiment, the confocal switching member 31 is formed with three pinholes 32a, 32b, 32c having different diameters from each other so that when biochemical analysis data are to be produced by scanning the micro-array 22 in which a plurality of spots of a specimen selectively labeled with a fluorescent dye are formed on the slide glass plate 23 to stimulate the fluorescent dye and photoelectrically detecting fluorescence emission released from the fluorescent dye, the pinhole 32a is used, when biochemical analysis data are to be produced by scanning the stimulable phosphor layer of the stimulable phosphor sheet in which locational information of a radioactive labeling substance obtained by exposing the stimulable phosphor layer to radiation is recorded with a laser beam 4 to stimulate a stimulable phosphor and photoelectrically detecting stimulated emission released from the stimulable phosphor, the pinhole 32b is used and when biochemical analysis data are to be produced by scanning the fluorescence sample including a transfer support including a specimen electrophoresed thereon and selectively labeled with a fluorescent dye with a laser beam 4 to stimulate the fluorescent dye and photoelectrically detecting fluorescence emission released from the fluorescent dye, the pinhole 32c is used. However, it is possible to form only the pinholes 32a, 32b in the confocal switching member 31 so that when biochemical analysis data are to be produced by scanning the micro-array 22 in which a plurality of spots of a specimen selectively labeled with a fluorescent dye are formed on the slide glass plate 23 to stimulate the fluorescent dye and photoelectrically detecting fluorescence emission released from the fluorescent dye, fluorescence emission is detected through the pinhole 32a, when biochemical analysis data are to be produced by photoelectrically detecting stimulated emission 25 released from the stimulable phosphor layer, the stimulated emission is detected through the pinhole 32b and when biochemical analysis data are to be produced by photoelectrically detecting fluorescence emission released from the transfer support, the confocal switching member 31 is retracted from the optical path of fluorescence emission, thereby increasing the light amount received by the photomultiplier 33, and it is also possible to form only the pinhole 32a in the confocal switching member 31 so that only when biochemical analysis data are to be produced by scanning the micro-array 22 in which a plurality of spots of a specimen selectively labeled with a fluorescent dye are formed on the slide glass plate 23 to stimulate the fluorescent dye and photoelectrically detecting fluorescence emission released from the fluorescent dye, fluorescence emission is detected through the pinhole 32a and when biochemical analysis data are to be produced by photoelectrically detecting stimulated emission 25 released from the stimulable phosphor layer and when biochemical analysis data are to be produced by photoelectrically detecting fluorescence emission released from the transfer support, the confocal switching member 31 is retracted from the optical path of fluorescence emission, thereby increasing the light amount received by the photomultiplier 33.

Moreover, in the above described embodiment, although the image reading apparatus includes the first laser stimulating ray source 1, the second laser stimulating ray source 2 and the third laser stimulating ray source 3, it is sufficient for the image reading apparatus to be able to effectively stimulate a fluorescent dye contained in specimen solutions and a fluorescent dye used as a labeling substance and detect fluorescence emission released from all spots 24 and the labeling substance and it is not absolutely necessary for the image reading apparatus to include three laser stimulating ray sources.

Further, in the above described embodiment, although a semiconductor laser beam source for emitting a laser beam 4 having a wavelength of 640 nm is employed as the first laser stimulating ray source 1, a He—Ne laser beam source for emitting a laser beam 4 having a wavelength of 633 nm or a semiconductor laser beam source for emitting a laser beam 4 having a wavelength of 635 nm may be employed instead of the semiconductor laser beam source for emitting a laser beam 4 having a wavelength of 640 nm.

Furthermore, in the above described embodiment, a laser beam source for emitting a laser beam 4 having a wavelength of 532 nm is used as the second laser stimulating ray source 2 and a laser beam source for emitting a laser beam 4 having a wavelength of 473 nm is used as the third laser stimulating ray source 3. However, depending upon the kind of a fluorescent substance, a laser beam source for emitting a laser beam 4 having a wavelength of 530 to 540 nm may be used as the second laser stimulating ray source 2 and a laser beam source for emitting a laser beam 4 having a wavelength of 470 to 480 nm may be used as the third laser stimulating ray source 3.

Moreover, in the above described embodiment, the entire surface of the DNA micro-array 22 is scanned with a laser beam 4 by reciprocating the sample stage 20 at a high speed in the main scanning direction indicated by an arrow X in FIG. 4 by the main scanning motor 43 and moving the sample stage 20 in the sub-scanning direction indicated by an arrow Y in FIG. 4 by the sub-scanning motor 47. However, the entire surface of the DNA micro-array 22 may be scanned with a laser beam 4 by moving the optical head 15 in the main scanning direction indicated by an arrow X in FIG. 1 and in the sub-scanning direction indicated by an arrow Y in FIG. 1, while holding the sample stage 20 stationary or the entire surface of the DNA micro-array 22 may be scanned with a laser beam 4 by moving the optical unit 15 in the main scanning direction indicated by an arrow X in FIG. 1 or in the sub-scanning direction indicated by an arrow Y in FIG. 1 and moving the sample stage 20 in the sub-scanning direction indicated by an arrow Y in FIG. 1 or in the main scanning direction indicated by an arrow X in FIG. 1.

Further, in the above described embodiment, although the perforated mirror 18 formed with the hole 17 is used in the above described embodiments, the mirror can be formed with a coating capable of transmitting the laser beam 4 instead of the hole 17.

Furthermore, the photomultiplier 33 is employed as a light detector to photoelectrically detect fluorescence emission released from a fluorescent dye contained in the DNA micro-array 22 and stimulated emission released from a stimulable phosphor in the above described embodiments. However, it is sufficient for the light detector used in the present invention to be able to photoelectrically detect at least fluorescence emission and it is possible to employ a light detector such as a line CCD and a two-dimensional CCD instead of the photomultiplier 33.

Moreover, although an image is displayed on the screen of the CRT 63 in the above described embodiment, the display means for displaying an image is not limited to the CRT 63 and instead of a CRT 63, a flat display panel such as a liquid crystal display panel, an organic EL display panel or the like may be used.

According to the present invention, it is possible to provide an image analyzing method and apparatus for detecting a micro-array image, which can define a region of interest to be quantitatively analyzed in a desired manner and accurately effect quantitative analysis.

1. An image analyzing method comprising the steps of spot-like dropping a specific binding substance onto a substrate to form a plurality of spots, photoelectrically detecting all of the thus formed spots to produce template data, producing a template for defining regions of interest to be quantified based on the thus produced template data and effecting quantitative analysis based on the template.

2. An image analyzing method in accordance with claim 1 which comprises the steps of spot-like dropping a fluorescent dye for producing template data capable of being efficiently stimulated by a stimulating ray having a different wavelength from that of a stimulating ray capable of efficiently stimulating a fluorescent dye labeling a target substance derived from a living organism onto the substrate together with the specific binding substance to form a plurality of spots, irradiating the plurality of spots with a stimulating ray having a wavelength capable of efficiently stimulating the fluorescent dye for producing template data, thereby stimulating the fluorescent dye for producing template data, photoelectrically detecting fluorescence emission released from the fluorescent dye for producing template data, producing the template data, producing a template for defining regions of interest to be quantified based on the thus produced template data and effecting quantitative analysis based on the template.

3. An image analyzing method in accordance with claim 2 which comprises the steps of spot-like dropping the fluorescent dye for producing template data onto the substrate together with the specific binding substance to form the plurality of spots, hybridizing the substance derived from a living organism and labeled with a fluorescent dye with the specific binding substance, irradiating the plurality of spots with a stimulating ray having a wavelength capable of efficiently stimulating the fluorescent dye for producing template data, thereby stimulating the fluorescent dye for producing template data, photoelectrically detecting fluorescence emission released from the fluorescent dye for producing template data, producing the template data, producing the template for defining regions of interest to be quantified based on the thus produced template data, irradiating the plurality of spots with a stimulating ray capable of efficiently stimulating the fluorescent dye to stimulate the fluorescent dye labeling the substance derived from a living organism, photoelectrically detecting fluorescence emission released from the fluorescent dye to produce image data, and effecting quantitative analysis based on the template.

4. An image analyzing method in accordance with claim 2 which comprises the steps of spot-like dropping the fluorescent dye for producing template data onto the substrate together with the specific binding substance to form the plurality of spots, hybridizing the substance derived from a living organism and labeled with a fluorescent dye with the specific binding substance, irradiating the plurality of spots with a stimulating ray having a wavelength capable of efficiently stimulating the fluorescent dye labeling the substance derived from a living organism to stimulate the fluorescent dye, photoelectrically detecting fluorescence emission released from the fluorescent dye to produce image data, irradiating the plurality of spots with a stimulating ray having a wavelength capable of efficiently stimulating the fluorescent dye for producing template data, thereby stimulating the fluorescent dye for producing template data, photoelectrically detecting fluorescence emission released from the fluorescent dye for producing template data, producing a template data, producing a template for defining regions of interest to be quantified based on the thus produced template data, and effecting quantitative analysis based on the template.

5. An image analyzing method in accordance with claim 2 which comprises the steps of spot-like dropping the fluorescent dye for producing template data onto the substrate together with the specific binding substance to form the plurality of spots, irradiating the plurality of spots with a stimulating ray having a wavelength capable of efficiently stimulating the fluorescent dye for producing template data, thereby stimulating the fluorescent dye for producing template data, photoelectrically detecting fluorescence emission released from the fluorescent dye for producing template data, producing the template data, producing a template for defining regions of interest to be quantified based on the thus produced template data, hybridizing the substance derived from a living organism and labeled with a fluorescent dye with the specific binding substance forming the plurality of spots on the substrate, irradiating the plurality of spots with a stimulating ray having a wavelength capable of efficiently stimulating the fluorescent dye labeling the substance derived from a living organism to stimulate the fluorescent dye, photoelectrically detecting fluorescence emission released from the fluorescent dye to produce image data, defining regions of interest to be quantified in the image data based on the template and effecting quantitative analysis based on the template.

6. An image analyzing method in accordance with claim 2 wherein the fluorescent dye for producing template data is contained in a polymer and which comprises the steps of causing the polymer to contain the specific binding substance, spot-like dropping the polymer onto the substrate to form a plurality of spots, irradiating the plurality of spots with a stimulating ray having a wavelength capable of efficiently stimulating the fluorescent dye for producing template data, thereby stimulating the fluorescent dye for producing template data, photoelectrically detecting fluorescence emission released from the fluorescent dye for producing template data, producing the template data, producing the template for defining regions of interest to be quantified based on the thus produced template data, and effecting quantitative analysis based on the template.

7. An image analyzing method in accordance with claim 6 wherein the fluorescent dye for producing template data is contained in the polymer and which comprises the steps of causing the polymer to contain the specific binding substance, spot-like dropping the polymer onto the substrate to form the plurality of spots, hybridizing the substance derived from a living organism and labeled with a fluorescent dye with the specific binding substance, irradiating the plurality of spots with a stimulating ray having a wavelength capable of efficiently stimulating the fluorescent dye for producing template data, thereby stimulating the fluorescent dye for producing template data, photoelectrically detecting fluorescence emission released from the fluorescent dye for producing template data, producing the template data, producing a template for defining regions of interest to be quantified based on the thus produced template data, irradiating the plurality of spots with a stimulating ray having a wavelength capable of efficiently stimulating the fluorescent dye labeling the substance derived from a living organism to stimulate the fluorescent dye, photoelectrically detecting fluorescence emission released from the fluorescent dye to produce image data, and effecting quantitative analysis based on the template.

8. An image analyzing method in accordance with claim 6 wherein the fluorescent dye for producing template data is contained in the polymer and which comprises the steps of causing the polymer to contain the specific binding substance, spot-like dropping the polymer onto the substrate to form the plurality of spots, hybridizing the substance derived from a living organism and labeled with a fluorescent dye with the specific binding substance, irradiating the plurality of spots with a stimulating ray having a wavelength capable of efficiently stimulating the fluorescent dye labeling the substance derived from a living organism, thereby stimulating the fluorescent dye, photoelectrically detecting fluorescence emission released from the fluorescent dye to produce image data, irradiating the plurality of spots with a stimulating ray having a wavelength capable of efficiently stimulating the fluorescent dye for producing template data, thereby stimulating the fluorescent dye for producing template data, photoelectrically detecting fluorescence emission released from the fluorescent dye for producing template data, producing the template data, producing a template for defining regions of interest to be quantified based on the thus produced template data, and effecting quantitative analysis based on the template.

9. An image analyzing method in accordance with claim 1 which comprises the steps of dropping a solution containing the fluorescent dye for producing template data onto the substrate using a spotter to form the plurality of spots, irradiating the plurality of spots with a stimulating ray having a wavelength capable of efficiently stimulating the fluorescent dye for producing template data, thereby stimulating the fluorescent dye for producing template data, photoelectrically detecting fluorescence emission released from the fluorescent dye for producing template data, producing the template data, producing a template for defining regions of interest to be quantified based on the thus produced template data, dropping a solution containing the specific binding substance using the spotter onto another substrate to form a plurality of spots, hybridizing the substance derived from a living organism and labeled with a fluorescent dye with the specific binding substance, irradiating the plurality of spots with a stimulating ray having a wavelength capable of efficiently stimulating the fluorescent dye labeling the substance derived from a living organism, thereby stimulating the fluorescent dye, photoelectrically detecting fluorescence emission released from the fluorescent dye to produce image data, defining regions of interest to be quantified in the image data, and effecting quantitative analysis.

10. An image analyzing method in accordance with claim 1 which comprises the steps of spot-like dropping the specific binding substance onto the substrate to form the plurality of spots, irradiating the plurality of spots with light, photoelectrically detecting light scattered by the plurality of spots to produce template data, and producing a template for defining regions of interest to be quantified based on the thus produced template data.

11. An image analyzing method in accordance with claim 10 which comprises the steps of spot-like dropping the specific binding substance onto the substrate to form the plurality of spots, hybridizing the substance derived from a living organism and labeled with a fluorescent dye with the specific binding substance, irradiating the plurality of spots with a stimulating ray having a wavelength capable of efficiently stimulating the fluorescent dye, photoelectrically detecting light scattered by the plurality of spots to produce template data, producing a template for defining regions of interest to be quantified based on the thus produced template data, irradiating the plurality of spots with a stimulating ray having a wavelength capable of efficiently stimulating the fluorescent dye, thereby stimulating the fluorescent dye labeling the substance derived from a living organism, photoelectrically detecting fluorescence emission released from the fluorescent dye to produce image data, defining regions of interest to be quantified in the image data based on the template, and effecting quantitative analysis.

12. An image analyzing method in accordance with claim 10 which comprises the steps of spot-like dropping the specific binding substance onto the substrate to form the plurality of spots, hybridizing the substance derived from a living organism and labeled with a fluorescent dye with the specific binding substance, irradiating the plurality of spots with a stimulating ray having a wavelength capable of efficiently stimulating the fluorescent dye, thereby stimulating the fluorescent dye, photoelectrically detecting fluorescence emission released from the fluorescent dye to produce image data, irradiating the plurality of spots with a stimulating ray having a wavelength capable of efficiently stimulating the fluorescent dye, photoelectrically detecting light scattered by the plurality of spots to produce template data, producing a template for defining regions of interest to be quantified based on the thus produced template data, defining regions of interest to be quantified in the image data based on the template, and effecting quantitative analysis.

13. An image analyzing apparatus comprising at least two stimulating ray sources, a light detector and an image reading apparatus for producing image data by photoelectrically detecting fluorescence emission by the light detector, the image analyzing apparatus further comprising template producing means for producing a template based on template data produced by photoelectrically detecting by the light detector of the image reading apparatus all of the spots of a specific binding substance formed on a substrate by spot-like dropping the specific binding substance and defining regions of interest to be quantified based on the template, and quantitative analyzing means for defining regions of interest to be quantified in the image data based on the template produced by the template producing means and effecting quantitative analysis.

14. An image analyzing apparatus in accordance with claim 13 wherein the image reading apparatus is constituted so as to irradiate a plurality of spots formed by spot-like dropping a fluorescent dye for producing template data capable of being efficiently stimulated by a stimulating ray having a different wavelength from that of a stimulating ray capable of efficiently stimulating a fluorescent dye labeling a target substance derived from a living organism onto the substrate together with the specific binding substance with a stimulating ray emitted from one of the at least two stimulating ray sources to stimulate the fluorescent dye and produce template data by photoelectrically detecting fluorescence emission released from the fluorescent dye for producing template data by the light detector.

15. An image analyzing apparatus in accordance with claim 14 wherein the image reading apparatus is constituted so as to irradiate a specimen obtained by spot-like dropping the fluorescent dye for producing template data onto the substrate together with the specific binding substance to form the plurality of spots and hybridizing the substance derived from a living organism and labeled with a fluorescent dye with the specific binding substance with a stimulating ray having a wavelength capable of efficiently stimulating the fluorescent dye for producing template data and emitted from one of the at least two stimulating ray sources to stimulate the fluorescent dye for producing template data, irradiate the fluorescent dye labeling the substance derived from a living organism with a stimulating ray having a wavelength capable of efficiently stimulating the fluorescent dye and emitted from the other of the at least two stimulating ray sources to stimulate the fluorescent dye, produce template data by photoelectrically detecting fluorescence emission released from the fluorescent dye for producing template data by the light detector, and produce image data by photoelectrically detecting fluorescence emission released from the fluorescent dye labeling the substance derived from a living organism, the template producing means is constituted so as to produce the template based on the template data, and the quantitative analyzing means is constituted so as to effect template fitting between the template produced by the template producing means and the image data, thereby defining regions of interest in the image data and effecting quantitative analysis.

16. An image analyzing apparatus in accordance with claim 14 wherein the image reading apparatus is constituted so as to irradiate a specimen including a plurality of spots formed by spot-like dropping the fluorescent dye for producing template data onto the substrate together with the specific binding substance with a stimulating ray having a wavelength capable of efficiently stimulating the fluorescent dye for producing template data and emitted from one of the at least two stimulating ray sources to stimulate the fluorescent dye for producing template data, produce template data by photoelectrically detecting fluorescence emission released from the fluorescent dye by the light detector, further irradiate a specimen obtained by hybridizing the substance derived from a living organism and labeled with a fluorescent dye with the specific binding substance forming the plurality of spots on the substrate with a stimulating ray having a wavelength capable of efficiently stimulating the fluorescent dye and emitted from the other of the at least two stimulating ray sources to stimulate the fluorescent dye, and produce image data by further photoelectrically detecting fluorescence emission released from the fluorescent dye labeling the substance derived from a living organism by the light detector, the template producing means is constituted so as to produce the template based on the template data, and the quantitative analyzing means is constituted so as to effect template fitting between the template produced by the template producing means and the image data, thereby defining regions of interest in the image data and effecting quantitative analysis.

17. An image analyzing apparatus in accordance with claim 14 wherein the image reading apparatus is constituted so as to irradiate a specimen including a plurality of spots formed by spot-like dropping a polymer containing the specific binding substance and the fluorescent dye for producing template data onto the substrate with a stimulating ray having a wavelength capable of efficiently stimulating the fluorescent dye for producing template data and emitted from one of the at least two stimulating ray sources to stimulate the fluorescent dye for producing template data, and produce template data by photoelectrically detecting fluorescence emission released from the fluorescent dye for producing template data by the light detector.

18. An image analyzing apparatus in accordance with claim 14 which further comprises data storing means for storing data produced by the image reading apparatus and the image reading apparatus is constituted so as to irradiate a plurality of spots formed by spot-like dropping a solution containing a fluorescent dye for producing template data onto a substrate using a spotter with a stimulating ray having a wavelength capable of efficiently stimulating the fluorescent dye for producing template data and emitted from one of the at least two stimulating ray sources to stimulate the fluorescent dye for producing template data, photoelectrically detect fluorescence emission released from the fluorescent dye for producing template data by the light detector, thereby producing template data and storing them in the data storing means, irradiate a specimen including a plurality of spots formed by spot-like dropping a solution containing the specific binding substance onto another substrate using the spotter and hybridizing the substance derived from a living organism labeled with a fluorescent dye with the specific binding substance with a stimulating ray having a wavelength capable of efficiently stimulating the fluorescent dye and emitted from the other of the at least two stimulating ray sources to stimulate the fluorescent dye, photoelectrically detect fluorescence emission released from the fluorescent dye by the light detector, thereby producing image data, the template producing means is constituted so as to produce a template based on the template data stored in the data storing means, and the quantitative analyzing means is constituted so as to effect template fitting between the template produced by the template producing means and the image data, thereby defining regions of interest in the image data and effect quantitative analysis.

19. An image analyzing apparatus in accordance with claim 13 wherein the image reading apparatus is constituted so as to irradiate a plurality of spots formed by spot-like dropping the specific binding substance onto the substrate with light and photoelectirically detect light scattered by the plurality of spots, thereby producing template data, the template producing means is constituted so as to produce a template based on the template data, and the quantitative analyzing means is constituted so as to define regions of interest to be quantified based on the template and effect quantitative analysis.

20. An image analyzing apparatus in accordance with claim 19 wherein the image reading apparatus further comprises a filter detachably mounted on a front surface for cutting a light component of a wavelength of a stimulating ray and is constituted so as to irradiate, while the filter is detached, a specimen including a plurality of spots formed by spot-like dropping the specific binding substance onto the substrate and hybridizing the substance derived from a living organism and labeled with a fluorescent dye with the specific binding substance with a stimulating ray having a wavelength capable of effectively stimulating the fluorescent dye, photoelectrically detect light of the stimulating ray scattered by the plurality of spots by the light detector, thereby producing template data, and is also constituted so as to irradiate, while the filter is attached, the plurality of spots with a stimulating ray having a wavelength capable of effectively stimulating the fluorescent dye, thereby stimulating the fluorescent dye, photoelectrically detect fluorescence emission released from the fluorescent dye, thereby producing image data by the light detector, the template data producing means is constituted so as to produce a template based on the template data, and the quantitative analyzing means is constituted so as to effect template fitting between the template and the image data, thereby defining regions of interest to be quantified in the image data and effecting quantitative analysis.
